(19) United States
(12) Patent Application Publication
(10) Pub. No.: US 2014/0207815 A1
(43) Pub. Date: Jul. 24, 2014

(54) METHOD, SYSTEM AND COMPUTER PROGRAM FOR MANAGING SOCIAL NETWORKING SERVICE INFORMATION

(71) Applicant: YANDEX EUROPE AG, Luzern (CH)

(72) Inventors: Maxim GRINEV, Palo Alto, CA (US); Maria GRINEVA, Palo Alto, CA (US); Sergey FAYFER, Moscow (RU); Martin HENTSCHEL, Pirna (RU)

(73) Assignee: YANDEX EUROPE AG, Luzern (CH)

(21) Appl. No.: 13/784,913

(22) Filed: Mar. 5, 2013

Related U.S. Application Data
(60) Provisional application No. 61/754,381, filed on Jan. 18, 2013.

(30) Foreign Application Priority Data
Jan. 24, 2013 (US) PCT/US2013/022864

(51) Int. Cl. G06F 17/30

(52) U.S. Cl. CPC G06F 17/30283
USPC 707/769

(57) ABSTRACT

Method for managing social networking service information of a first user, comprising: retrieving from a first social networking service first information in respect of at least one second user of the first social networking service; storing the retrieved first information in a database; retrieving from a second social networking service second information in respect of at least one third user; storing the retrieved second information in the database; receiving a search query from a client device; effecting a search of the database in respect of the search query; and sending results of the search to the client device of the first user. Systems and computer program related to the methods are also disclosed.

### CROSS-REFERENCE TO RELATED APPLICATIONS

The present application claims priority to U.S. provisional patent application No. 61/754,381, filed Jan. 18, 2013, entitled “Method, System and Computer Program for Managing Social Networking Service Information” and to International patent application number PCT/US2013/022864, filed Jan. 24, 2013 with the United States Receiving Office, entitled “Method, System and Computer Program for Managing Social Networking Service Information”. The contents of both of these applications are incorporated by reference herein in their entirety.

### FIELD

The present specification relates to methods of, and systems and computer programs for, managing social networking service information.

### BACKGROUND

Despite their relatively recent creation, social networking services have become a main source of information for many people. For example, many people get news via Facebook™ and Twitter™; they learn about new places via Instagram™ and Foursquare™; and they learn about new music via Spotify™ and Rdio™ (via Facebook or Twitter integration, for example). The amount of information being generated in social networking services is extraordinarily large and is growing every day. For example, Twitter users post around 400 million “tweets” per day; Foursquare claims that there are millions of “check-ins” per day; more than 5 million photos are uploaded to Instagram per day, and Spotify users listened to 13 billion songs during the first year that the service was available in the United States.

Despite this voluminous amount of information, there is, at present a lack of methods and systems to manage such information and render it more useful. Improvements in this area might be beneficial.

### SUMMARY

The creators of the present technology have realized that (at least some) information from social networking services can potentially be used to provide users of such services with information that might be more useful to them than would be general information conventionally available on the Internet.

As an example, suppose a person is looking for information regarding “good” restaurants in Miami. (“Good” being subjective in respect of the person looking for the restaurants.) The person could type the search query “good restaurant in Miami” into a traditional Internet search engine such as Google™. What might be returned as a result of that search could be links to restaurant reviews in a Miami newspaper such as the Miami Herald™, to a commercial restaurant guide such as Zagat™, or to restaurant reviewing websites such as Urbanspoon™ or Yelp™ (which allow persons having eaten at restaurants to post comments on blogs for example). While all of this information might be helpful to the person in selecting a restaurant, in most cases there is at least one significant drawback to information from sources such as these. The person doing the search in almost all cases will not know the actual persons who have rated the restaurants in question or have provided comments on their dining experience, etc. Thus, the person doing the search may be at a disadvantage in knowing what information to trust and what not to trust, since they do not know the reviewers themselves. Further, even if all of the information is trustworthy, in all likelihood none of those people know the actual person doing the search in question and therefore they do not know what that particular person would like or dislike. Therefore the information currently available via this type of conventional Internet search on this type of search query may not be optimal.

More particularized information (and thus potentially more useful information) might be available to person were they to able to conduct a search such as “What restaurants in Miami do my friends like?” Were the person able to have that question answered they might be able to find a “good” restaurant more suited to them as they would likely know their friend(s) in question and therefore might be able to know whose advice would be better suited for them in a particular situation. Unfortunately neither conventional Internet search engines (e.g. Google, Bing™, Yahoo™, Yandex™) nor conventional social networking service sites (such those mentioned above, for example) are currently able to handle such search requests.

It is therefore an object of the technology disclosed in the present specification to ameliorate at least one of the inconveniences present in the prior art (irrespective of whether such inconvenience is described herein).

It is a further object of the technology disclosed in the present specification to provide an improved method of and system for managing social networking service information.

Thus, in one aspect, certain implementations of the present technology provide a method for managing social networking service information of a first user comprising:
retrieving from a first social networking service, via at least one server, first information in respect of at least one second user of the first social networking service having been identified by the first user as related to the first user;
storing the retrieved first information in at least one first database in operational communication with the at least one server;
retrieving from a second social networking service, via the at least one server, second information in respect of at least one third user having been identified by the first user as related to the first user;
storing the retrieved second information in the at least one first database in operational communication with the at least one server;
receiving, via the at least one server, a search query from a client device of the first user;
effecting a search of the at least first one database in respect of the search query via the at least one server; and
sending, via the at least one server, results of the search to the client device of the first user.

A social networking service is an online service, platform, or site that focuses on facilitating the building of social networking or social relations among people, who, for example, share interests, activities, backgrounds, or real-life connections. Users of social networking services have (in many cases) many dyadic relationships between them. The name and type of these relationships vary among the various social networking services. For example, users of Facebook may designate other users of the service as their “friends”; users of Twitter can choose to become “followers” of other users of the service. In the context of the present specification, the actual name or type of relationship is not of particular importance. It is the existence of the relationship that is, as it is the existence of the relationship that assists the social networking service in question to determine what might be particularly relevant to a user in question. For example, the social networking service Facebook contains what is known as a “news feed”. The news feed is a constantly updating list of information from other users of the service that the user in question is “following”. Facebook allows the user in question to customize what information appears in their news feed. Facebook also allows a user being followed to determine what users following them will be able to see in the latters' news feeds.

The information in a Facebook user's news feed is more likely to be particularly relevant to them in some situations than would be non-particularized information generally available on the Internet. For example, the social networking service Foursquare allows a user of its service to login with their Facebook credentials and to send information regarding their Foursquare “check-ins” to Facebook. Assuming the user has so configured their Facebook account, the check-in information will then appear as part of the news feed of any users following that user (who have so configured their account to have such information appear as part of their news feed). (The foregoing is simply an illustrative example. In another example Foursquare information may be sent by a user to other users following them using Foursquare “pings” and not via the intermediary of a Facebook news feed.) Among the information that may be sent via a Foursquare is the user's specific location as well as comments about that location. For instance, if their location is a restaurant that user may send comments about the restaurant. As was discussed above, were this information searchable, it might be useful in certain situations. (There are currently very limited searching options available on social networking services, and none in respect of more than one social networking service.) Implementations of the present technology attempt to do just that; render such social networking service information useful to users of such surfaces.

The present technology involves the aggregation of relevant from various (i.e. at least two) different social networking services, of users related to the user desirous of having a search performed, in a searchable database and allows for such information to be rendered searchable. (In the context of the present specification the user of a social network service desirous of having a search performed is termed “a first user”, and users of at least one social networking service in common with the first user identified as being related to the first user are termed “a second user” and “a third user” (as the case may be).)

Users of a social networking service may be related to one either directly (on Facebook, for example, by being “friends”) or indirectly (on Facebook, for example, by being “friends of friends”). Both direct and indirect relationships fall within the definition of a user of social networking services having been identified by another user as being related to the user in the present context. (The expression “identified by the first user . . . ” is meant to indicate that the first user has taken some action (or omission of action) that has directly or indirectly caused the first user and the second user or the third user, etc. to be related in respect of the social networking service. Real-life relationships between users of a social networking who have no identified relationship present in a social networking service in question are excluded. (For example, two users who are real-life sisters, but are not Facebook “friends” would not, for the purposes of considering Facebook as a social networking service, be related.))

Therefore, for example, information in such searchable database (termed a first database hereinbelow) of the present technology might be related to restaurants at which the persons have an identified social networking service relationship (e.g. a second user, a third user) have eaten, how often they have eaten there, and what comments they have on the restaurant, if any. This aggregated information will have been obtained, be it directly or indirectly, from more than one social networking service, such as, for instance, Facebook and Foursquare. (Although it is not likely that all information will be been obtained from both services, likely some will have been obtained from one and some from the other) Thus, referring back to the previous example of finding a good restaurant in Miami, the information stored in the searchable database could be used to answer the question “where do my friends eat at in Miami?”, which may, depending on the circumstances provide more useful information than the conventional Internet search on using the query “good restaurants in Miami” described above. (The “friends” in the aforementioned query being the aggregate of the second user, the third user, etc.)

In the context of the present specification, a “server” is a computer program that is running on appropriate hardware and is capable of receiving requests (from client devices) over a network, and carrying out those requests, or causing those requests to be carried out. The hardware may be one physical computer or one physical computer system, but neither is required to be the case with respect to the present technology. In the present context, the use of the expression “at least one server” is not intended to mean that every task (e.g. received instructions or requests) or any particular task will have been received, carried out, or caused to be carried out, by the same server (i.e. the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, “a client device” is any computer hardware that is capable of running software appropriate to the relevant task at hand. Thus, some (non-limiting) examples of client devices include personal computers (desktops, laptops, netbooks, etc.), smartphones, and tablets. The use of the expression “at least one client device” is used to indicate that multiple client devices may be used in receiving/sending, carrying out or causing to be carried out any task or request, or the consequences of any task or request, or steps of any method described herein. For example, it is foreseen that in certain implementations described in greater detail hereinbelow, a user may provide credentials in respect of social networking service(s) on a personal computer(s) but may provide search queries on a smartphone. In such instances, the personal computer and the smartphone are together “at least one client device” as is used herein.

In the context of the present specification, a “database” is any structured collection of data, irrespective its particular structure, database management software, or computer hardware on which the data is stored, implemented or otherwise rendered available for use. A database is in “operational communication” in the present context when it is rendered available for use as part of a database management system that is itself connected to an accessible communications network.

In the present context, the expression “information” includes information of any nature or kind whatsoever capable of being stored in a database. Thus information includes, but is not limited to audiovisual works (pictures, movies, sound records, etc.) location data, text (opinions, comments, questions, messages, etc.), etc.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first information” and “third information” is not intended to imply any particular order, type, chronology, hierarchy or ranking (for example) of/between the information, nor is their use (by itself) intended imply that any “second information” must necessarily exist in any given situation.

In some implementations, retrieving from a first social networking service, via at least one server, first information in respect of at least one second user having been identified by the first user as related to the first user includes retrieving information from a news feed of the first user on the first social networking service on a first periodic basis. (For example, every X minutes) Thus, for example, in a certain implementations of the present method, information from Facebook “news feeds” of the Facebook “friends” of a user may be periodically (relatively frequently) be retrieved and stored. It should be understood that in the present context, however, a “news feed” is not limited to the “news feed” of the Facebook social networking service. A news feed is any (relatively) frequently automatically (i.e. without having a specific request to do so) updated data source (of data in respect of a user in question) of a social networking service. So the “tweets” of a Twitter user would comprise a news feed, and in the present context would be retrieved and stored were a user in question to be following that Twitter user.

In some implementations, retrieving from a first social networking service, via at least one server, first information in respect of at least one second user having been identified by the first user as related to the first user includes retrieving information from the first social networking service via an API (application programming interface) of the first social networking service on a second period basis. In this respect a request is made via an appropriate API(s) of a social networking service (e.g. one constructed to allow for relevant information retrieval) for retrieval of information. The use of such API(s) may be in addition to, or in place of, retrieving information by some other method (such as via a news feed as described above). The method of information retrieval may change from time to time, from social networking service to social networking service, and/or from user to user, etc. It should be understood that the second periodic basis (described herein) may, but need not, be the same as the first periodic basis (described above).

In some implementations, the first social networking service and the second social networking service are operationally unrelated to each other. In this manner, via use of the present technology, information may from disparate social networking services be aggregated. In the context of the present invention, two social networking are operationally unrelated to each other if there is no link between them capable of sending information from at least one to the other (i.e. a one-way link—as opposed to a two way link). Thus, in the present context, Facebook and Foursquare are not unrelated to one another as it is possible for a user (of both services) to establish a link between them so that their Foursquare check-ins appear in the news feeds of Facebook users who are “friends” with the user in question (provided the relevant Facebook accounts have been so configured). By contrast, Facebook and Google+ are operationally unrelated to one another.

In some implementations, at least one of the at least one second user and at least one of the at least one third user is the same user. Thus, it is foreseen that it is possible that information being retrieved from social networking services may concern the same user(s) on two (or more) different services (or may concern different users on different services or both).

In some implementations, the method further comprises retrieving from a second database operationally unrelated to the first social networking service and the second networking service, via the at least one server, third information related to at least one of the first information and the second information. In some such implementations, the method further comprises storing the retrieved third information in the at least one first database. Thus, in addition to the information retrieved from the social networking services in question, information from database(s) unrelated to the social networking services in question may also be included in the searchable database (termed the “first database” hereinabove). For example, such additional information could have been obtained through services unrelated to social networking services such Google Maps, Wikipedia or 411.com and could be provided as part of the results of a search in respect of a relevant search query. Thus, for example location, contact, and map information could be provided as part of the results of search notwithstanding the fact that such information was not part of the information having been retrieved from a social networking service.

In another aspect, certain implementations of the present technology provide a method for managing social networking service information of a first user, comprising:
sending from a client device to at least one server, first credentials of the first user with respect to a first social networking service;
sending from the client device to the at least one server, second credentials of the first user with respect to a second social networking service;
sending from the client device to the at least one server, a search query in respect of first information having been received from the first social networking service in respect of at least one second user having been identified by the first user as related to the first user and in respect of second information having been received from the second social networking service in respect of at least one third user having been identified by the first user as related to the first user; and
receiving by the client device from the at least one server, results of a search having been effected in respect of the search query on the first information and the second information; and
providing the first user with the search results via a user interface of the client device.

In the context of the present specification, the “credentials” of a user with respect to social networking service include whatever information is required by a social networking service for a user to login to (e.g. authenticate themselves to) that social networking service. It should be understood that the credentials of a user with respect to one social networking service may actually be the credentials of a user with respect to a different social networking service. For example, it is commonly the case that users of a social networking service (other than Facebook) log into other social networking services (e.g. Foursquare) using their Facebook credentials. Thus in the present context, the “first credentials” and the “second credentials” may be the same credentials. A single sending of those credentials would be considered to be the simultaneous sending of both the first credentials and the second credentials for present purposes.

The user interface of a client device includes the elements of that device that allow for the input of information from the user of the device and/or the output of information to the user of the client device. Non-limiting examples include a device's screen, keyboard, microphone and speakers. No particular configuration of user interface is required in the context of the present technology; any user interface capable achieving its intended functions is sufficient.

In some implementations, first social networking service and the second social networking service are operationally unrelated to one another.

In some implementations, at least one of the at least one second user and at least one of the at least one third user is the same user.

In some implementations, the search has also been effected on third information having been received from a second database operationally unrelated to the first social networking service and the second social networking service, the third information being related to at least one of the first information and the second information.

In some implementations, the first user interface of the at least one client device includes a screen, the search appears on the screen as at least a user-navigable series of stacks, and a visual attribute of each stack provides an indication to the first user of a relative amount of the search results in that stack. Non-limiting examples of visual attributes include the presentation of a badge with each stack (or only some stacks) showing the amount of items in that stack, and varying the presentations of items of a stack within the presentation of the stack.

In some implementations, the first user interface of the at least one client device includes a screen and the search appears on the screen as at least user-navigable series of items, and the method further comprises providing the first user with additional information in respect of an item of the search results upon the first user gesturing on the screen of the client device. Non-limiting of such gestures include briefly touching the stack with a single (or a set or variable number of multiple) finger(s), reverse-pinching on the screen to expand the display of a stack and the pinching on the screen to collapse the display of a stack.

In some implementations, the method further comprises, prior to providing the user with the additional information, retrieving the additional information, by the client device, other than via the search in respect of the search query. In this respect, for example, the client device can (in addition to the information having been retrieved from the at least one server), itself retrieve information from a “third party” source outside of the search.

In another aspect, certain implementations of the present technology provide a computer system for managing social networking service information of a first user, comprising:
at least one data retrieval component that retrieves from a first social networking service first information in respect of at least one second user of the first social networking service having been identified by the first user as related to the first user, and that retrieves from a second social networking service section information in respect of at least one third user of the second social networking service having been identified by the first user as related to the first user;
at least one data storage component that stores the retrieved first information and the retrieved second information in a first database;
a search query reception component that receives a search query from a client device of the first user;
a search effecting component that effects a search of at least the first database in respect of the search query; and
a search result dispatch component that sends results of the search to the client device of the first user.

In the context of the present specification, the expression “component” is meant include software (appropriate to a particular hardware context) that is both necessary and sufficient to achieve the specific function(s) being referenced.

In some implementations, the at least one data retrieval component retrieves information from a news feed of the first user on the first social networking service on a first periodic basis.

In some implementations, the at least one data retrieval component retrieves information from the first social networking service via an API of the first social networking service on a second period basis.

In some implementations, the first social networking service and the second social networking service are operationally unrelated to each other.

In some implementations, at least one of the at least one second user and at least one of the at least one third user is the same user.

In some implementations, the computer system further comprises a third data retrieval component that retrieves third information from a second database operationally unrelated to the first social networking service and the second networking service, the third information related to at least one of the first information and the second information. In some such implementations, the at least one data storage component stores the retrieved third information in the at least one first database.

In another aspect, certain implementations of the present invention provide a computer system for managing social networking service information of a first user, comprising:
a credentials dispatch component that sends via a communications networking at least first credentials of the first user with respect to a first social networking service and second credentials of the first user with respect to a second social networking service;
a search query dispatch component that sends via the communications networking a search query in respect of first information having been received from the first social networking service in respect of at least one second user having been identified by the first user as related to the first user, and in respect of second information having been received from the second social networking service in respect of at least one third user having been identified by the first user as related to the first user; and
a search result reception component that receives via the communications networking results of a search having been effected in respect of the search query on the first information and the second information; and
a user interface control component that provides the first user with the search results via a user interface of the computer system.

In some implementations the first social networking service and the second social networking service are operationally unrelated to one another.

In some implementations, at least one of the at least one second user and at least one of the at least one third user is the same user.

In some implementations, the search has also been effected on third information having been received from a second database operationally unrelated to the first social networking service and the second social networking service, the third information being related to at least one of the first information and the second information.

In some implementations the first user interface of the computer system includes a screen, and a visual attribute of each stack provides an indication to the first user of a relative amount of the search results in that stack.

In some implementations, the first user interface of the at least one client device includes a screen and the search appears on the screen as at least user-navigable series of items, and the first user is provided with additional information in respect of an item of the search results upon the first user gesturing on the screen of the client device.

Some implementations further comprise an additional information retrieval component for retrieving the additional information other than via the search in respect of the search query.

In another aspect, certain implementations of the present technology provide a computer usable information storage medium having computer readable program code embodied thereon for managing social networking service information of a first user, the computer readable program code including instructions that when executed by a computer effect:
retrieval from a first social networking service of first information in respect of at least one second user of the first social networking service having been identified by the first user as related to the first user;
storage of the retrieved first information in at least one first database in operational communication with the computer;
retrieval from a second social networking service of second information in respect of at least one third user having been identified by the first user as related to the first user;
storage of the retrieved second information in the at least one first database in operational communication with the computer;
reception of a search query from a client device of the first user;
a search of the at least first one database in respect of the search query; and
dispatch of results of the search to the client device of the first user

In the context of the present specification, the expression “computer usable information storage medium” is intended to include media of any nature and kind whatsoever, including RAM, ROM, disks (CD-ROMs, DVDs, floppy disks, hard drivers, etc.), USB keys, solid state-drives, tape drives, etc.

In some implementations, retrieval from a first social networking service of first information in respect of at least one second user having been identified by the first user as related to the first user includes retrieval of information from a news feed of the first user on the first social networking service on a first periodic basis.

In some implementations, retrieval from a first social networking service of first information in respect of at least one second user having been identified by the first user as related to the first user includes retrieval of information from the first social networking service via an API of the first social networking service on a second period basis.

In some implementations, the first social networking service and the second social networking service are operationally unrelated to each other.

In some implementations, at least one of the at least one second user and at least one of the at least one third user is the same user.

In some implementations, the computer readable program code further includes instructions that when executed by the computer effect retrieval from a second database operationally unrelated to the first social networking service and the second networking service of third information related to at least one of the first information and the second information. In some such implementations, the computer readable program code further includes instructions that when executed by the computer effect storage of the retrieved third information in the at least one first database.

In another aspect, certain implementations of the present technology provide a computer usable information storage medium having computer readable program code embodied thereon for managing social networking service information of a first user, the computer readable program code including instructions that when executed by a computer effect:
dispatch via a communications networking of first credentials of the first user with respect to a first social networking service;
dispatch via the communications networking of second credentials of the first user with respect to a second social networking service;
dispatch via the communications networking of a search query in respect of first information having been received from the first social networking service in respect of at least one second user having been identified by the first user as related to the first user and in respect of second information having been received from the second social networking service in respect of at least one third user having been identified by the first user as related to the first user; and
reception of results of a search having been effected in respect of the search query on the first information and the second information; and
provision of the search results via a user interface of the computer.

In some implementations, the first social networking service and the second social networking service are operationally unrelated to one another.

In some implementations, at least one of the at least one second user and at least one of the at least one third user is the same user.

In some implementations, the search has also been effected on third information having been received from a second database operationally unrelated to the first social networking service and the second social networking service, the third information being related to at least one of the first information and the second information.

In some implementations, the user interface of the computer includes a screen, and during provision of the results of the search the results appear on the screen as at least a user-navigable series of stacks, a visual attribute of each stack provides an indication to the first user of a relative amount of the search results in that stack.

In some implementations, the user interface of the computer includes a screen, and during provision of the results of the search the results appear on the screen as at least a user-navigable series of items and the first user is provided with additional information in respect of an item of the search results upon the first user gesturing on the screen of the client device.

In some implementations, the computer readable program code further includes instructions that when executed by the computer effect, prior to provision of the user with the additional information, retrieval of the additional information, by the client device, other than via the search in respect of the search query.

Implementations of the present technology each have at least one of the above-mentioned object and/or aspects, but do not necessarily have all of them. It should be understood that some aspects of the present invention that have resulted from attempting to attain the above-mentioned object may not satisfy this object and/or may satisfy other objects not specifically recited herein.

Additional and/or alternative features, aspects, and advantages of implementations of the present invention will become apparent from the following description, the accompanying drawings, and the appended claims.

### BRIEF DESCRIPTION OF THE DRAWINGS

For a better understanding of the present invention, as well as other aspects and further features thereof, reference is made to the following description which is to be used in conjunction with the accompanying drawings, where:

FIG. 1 is a schematic diagram showing systems being implementations of the present technology.

FIG. 2 is a flow chart illustrating a method being an implementation of the present technology.

FIG. 3 is a flow chart illustrating a method being an implementation of the present technology.

FIG. 4 is a 1^{st} screen shot of a computer application (“app”) being an implementation of the present of the technology.

FIG. 5 is a 2^{nd} screen shot of the computer application first shown in FIG. 4.

FIG. 6 is a 3^{rd} screen shot of the computer application first shown in FIG. 4.

FIG. 7 is a 4^{th} screen shot of the computer application first shown in FIG. 4.

FIG. 8 is a 5^{th} screen shot of the computer application first shown in FIG. 4.

FIG. 9 is a 6^{th} screen shot of the computer application first shown in FIG. 4.

FIG. 10 is a 7^{th} screen shot of the computer application first shown in FIG. 4.

FIG. 11 is an 8^{th} screen shot of the computer application first shown in FIG. 4.

FIG. 12 is a 9^{th} screen shot of the computer application first shown in FIG. 4.

FIG. 13 is a 10^{th} screen shot of the computer application first shown in FIG. 4.

FIG. 14 is an 11^{th} screen shot of the computer application first shown in FIG. 4.

FIG. 15 is a 12^{th} screen shot of the computer application first shown in FIG. 4.

FIG. 16 is a 13^{th} screen shot of the computer application first shown in FIG. 4.

FIG. 17 is a 14^{th} screen shot of the computer application first shown in FIG. 4.

FIG. 18 is a 15^{th} screen shot of the computer application first shown in FIG. 4.

FIG. 19 is a 16^{th} screen shot of the computer application first shown in FIG. 4.

FIG. 20 is a 17^{th} screen shot of the computer application first shown in FIG. 4.

FIG. 21 is an 18^{th} screen shot of the computer application first shown in FIG. 4.

FIG. 22 is a 19^{th} screen shot of the computer application first shown in FIG. 4.

FIG. 23 is a 20^{th} screen shot of the computer application first shown in FIG. 4.

FIG. 24 is a 21⁴ screen shot of the computer application first shown in FIG. 4.

FIG. 25 is a 22^{nd} screen shot of the computer application first shown in FIG. 4.

FIG. 26 is a 23^{rd} screen shot of the computer application first shown in FIG. 4.

FIG. 27 is a 24^{th} screen shot of the computer application first shown in FIG. 4.

FIG. 28 is a 25^{th} screen shot of the computer application first shown in FIG. 4.

FIG. 29 is a 26^{th} screen shot of the computer application first shown in FIG. 4.

FIG. 30 is a 27^{th} screen shot of the computer application first shown in FIG. 4.

FIG. 31 is a 28^{th} screen shot of the computer application first shown in FIG. 4.

FIG. 32 is a 29^{th} screen shot of the computer application first shown in FIG. 4.

FIG. 33 is a 30^{th} screen shot of the computer application first shown in FIG. 4.

FIG. 34 is a 31^{st} screen shot of the computer application first shown in FIG. 4.

FIG. 35 is a 32^{nd} screen shot of the computer application first shown in FIG. 4.

FIG. 36 is a 33^{rd} screen shot of the computer application first shown in FIG. 4.

FIG. 37 is a 34^{th} screen shot of the computer application first shown in FIG. 4.

FIG. 38 is a 35^{th} screen shot of the computer application first shown in FIG. 4.

FIG. 39 is a 36^{th} screen shot of the computer application first shown in FIG. 4.

### DETAILED DESCRIPTION

Yandex Wonder App & Service

An illustrative example of the present technology is the Wonder™ app and service of Yandex Inc. of Palo Alto, Calif. The Wonder app is an application for use with the iPhone™ smartphone, iPad™ tablet computer and, iPod Touch™ music player (together referred to as “iPhone” hereinafter) sold by Apple Inc. (“Apple”™). The app has been designed using Apple's software development kit (and coded in the Objective-C programming language) in accordance with the design parameters required by Apple for applications to be included for distribution in Apple's App Store™

(It should be understood that while the present description uses the Wonder app iPhone implementation, other implementations of the present technology are possible, such as applications for other mobile operating systems (e.g. Android™, Windows Phone™, Blackberry OS™, etc.), applications for desktop operating systems (Windows™, Mac OS X™, etc.), and applications via a web browser, for example.)

The Wonder service includes the servers serving as the “backend” to the Wonder app. The functions of the Wonder service include the retrieval of information from various social networking services, storage of this information in a database (the Wonder service database), the execution of search queries in respect of the information stored in the database, and providing the search results to the Wonder app. (This list is intended to be illustrative and not limitative and the Wonder service may have additional functions. In addition, other implementations of the present technology do not have all of these functions and/or may have additional functions.) In this implementation the Wonder service servers incorporate code in the Java™ programming language.

Setup of the Wonder App & Service

The Wonder app is conventionally downloaded from the Apple App Store and installed on an iPhone. Once installed an icon for the app will appear on the home page of the iPhone. The app is started in a conventional manner by taping on the icon on the home page of the iPhone. (The user interface of the iPhone includes a touch screen as is well known in the art.) The iPhone is typically connected to a communications network, such as the Internet, via Wi-Fi or a mobile telephone network (such as AT&T™ in the United States). Through such communications network the iPhone may be in operational communication with servers which operate the backend of the Wonder service.

When the user starts the Wonder app for the first time, the app must be configured and the user must be registered with the Wonder service. To that end, the user will touch a settings button and will be presented with a request to log into the Wonder service using the user's Facebook credentials. (In other implementations other credentials could be used, Facebook is only being used herein as an example.) The Wonder app communicates the Facebook credentials to the Wonder service servers which in turn send the credentials to the Facebook social networking service (via the Internet), and, using the Open Authentication protocol, attempt to authenticate the user. If the authentication is successful, a unique identification of the user is created by the Wonder service servers and is stored in the Wonder service database (i.e. the information is passed to the database management software (in this implementation—the mySQL open source relational database—which effects the desired result). This unique identification is also sent to the Wonder app, which retains it and is able to provide it to the Wonder service servers as required to identify the user to the service.

Also, if the authentication is successful, the Facebook service will provide the Wonder service with a set of “keys” in respect of the user. The keys will be stored in the Wonder service database and will be used in the future for authentication with the Facebook service for the retrieval of data from the Facebook service. The Wonder service servers will then (immediately or within a relatively short time) make a call to the appropriate Facebook service APIs to retrieve information from the user's Facebook news feed. This information will be provided to the Wonder service servers by the Facebook service servers. Upon receipt of the information, the Wonder service servers effect the storage of the information in the Wonder service database for future use.

On a periodic basis, which, in this implementation, is every 15 minutes but may be longer based on system load, as long as the user remains a user of the Wonder service, the Wonder service servers will automatically retrieve and store information from the user's Facebook news feed in the Wonder service database and will render that information available for searching. This periodic retrieval and update process of the Wonder service is transparent to the user.

Returning to the setup process, once the user has successfully authenticated themselves to the Facebook social network service through the Wonder service, the user is then requested to provide their credentials for additional social networking services (e.g. Instagram, Foursquare, etc.), should they choose to do so. For each service for which the user provides credentials, an authentication request is made similar to the previously described request with respect to the Facebook service. Assuming the authentication request is successful, similar steps to those described above occur, and the Wonder service will proceed to retrieve information from that specific social networking service via that service's appropriate APIs. (What information is retrieved depends on the social networking service in question.) As was the case with the Facebook information, the retrieved information from another social networking service will then be stored in the Wonder service database, and through its having been associated in the Wonder service database with the user of the Wonder service in question, will be virtually aggregated with all of the other information having been retrieved from the other social networking services used by the user and registered with the Wonder service, and will be available for searching. As was the case with the Facebook service described above, the Wonder service servers will automatically periodically retrieve the latest information from each of the additional social networking services the user has registered with the Wonder service. (It should be understood that the periods of time may themselves be constant or may be variable over time. They may be the same or may vary amongst the various social networking services in question. No particular automatic update period is critical within the context of the present technology; it will vary amongst different implementations of the present technology.)

Once the user has set up their registration with the Wonder service, and the information from the various social networking services in question that they have registered with the Wonder service has been downloaded, they are ready to use the Wonder service. (The typical time that this takes may vary, but usually it is less than 60 minutes.)

(It should be understood that the foregoing discussion is simply provided for ease of understanding and is not intended to be a limitative description of the present technology. For example, the actual process by which the database storing the user's social networking service information (in the present example termed the Wonder service database) is populated with that information may vary amongst different implementations of the present technology.)

Schematic of the Wonder Service

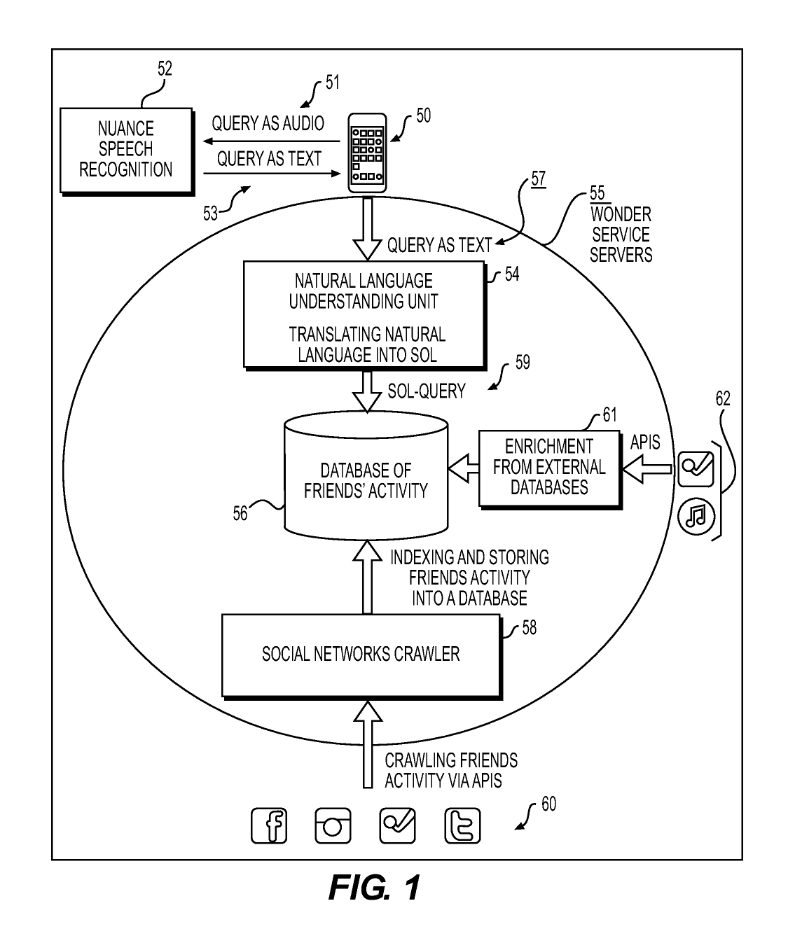

Referring now to FIG. 1, there is shown a schematic representation of the Wonder service in use, which can be briefly described as follows. In general, during the course of a day for example, an iPhone 50 having the Wonder app installed thereon is in (relatively) constant communication over a communications network (which may be the same or a different network as was used during the setup of the Wonder app/service, and which may or may not vary over the course of time).

Via the communications network, in this implementation of the present technology, the Wonder app on the iPhone will communicate as appropriate with a Nuance™ speech recognition system 52. The function of the Nuance™ speech recognition system 52 is to receive a voice input from the user of the iPhone 50 (via the microphone of the iPhone—in this implementation the microphone of the iPhone being a part of the iPhone's user interface) and to translate that voice input into text. As is shown in FIG. 1, a user desirous of using the Wonder system may speak a search query which will be captured by the iPhone's microphone, sent 51 to the Nuance speech recognition system 52 via the communications network, translated into text by the system, and returned 53 by the Nuance system to the Wonder app on the iPhone 50 as text.) (It should be understood the use of the Nuance system is not critical to present technology, and various conventional methods of speech-to-text conversion will suffice. It should also be understood that voice input is not a requirement of the present technology and various implementations may rely solely on, for example, direct text input by the user.)

As is also shown in FIG. 1, the iPhone 50 is also in communication over the communications network with the Wonder service servers 55. When the user is desirous of having a search conducted by the Wonder service servers 55, their search query 57 (which includes for present purposes their unique identification with the Wonder service) is transmitted by the Wonder app (on iPhone 50) to the Wonder service servers 55. This search query 57 is in text form (either having directly been entered in text form or having been converted into such, e.g. via the voice-to-text system described above).

After having received the search query 57 from the Wonder app, the Wonder service servers 55 will effect processing of the text of the search query 57 by a natural language understanding unit 54. The purpose the natural language understanding unit is to convert the received text search query into an SQL query 59 (irrespective of whether the search query had originally been received via voice and converted into text or had been entered directly by the user of the iPhone 50 as text). (The natural language understanding unit is, in this implementation, comprised of open source libraries. In other implementations it could be comprised of various open source and/or proprietary libraries and various combinations hereof.)

Once the natural language understanding unit has converted the search query 57 from text into SQL, the SQL query 59 is passed to the database management system (not shown) can receive SQL queries, execute them on the Wonder service database 56 and return the search results to the Wonder app on the iPhone 50 via the communications network. The Wonder app will then cause the display of the results of the search on the screen of the iPhone in a user-usable format.

Additional Information on the Wonder Service Schematic

As is shown, in FIG. 1, the Wonder service database 56 may be populated with information from various social networking services (for example those illustrated by the graphic logos 60 of the Facebook, Instagram, Foursquare & Twitter services) in respect of the user of the Wonder iPhone app. As was discussed hereinabove, the Wonder service servers will periodically retrieve information from those social networking services with which this user of the Wonder app has registered themselves and caused to be stored in the Wonder service database. This function is shown schematically in FIG. 1, as “crawler” 58.

The Wonder service database 56 is also populated with information 61 from external sources 62 (e.g. databases) unrelated to the social networking services; such information being related to the information having been received from the social network services. For example, in this implementation the information being stored in the Wonder service database is reviewed for song title information. A call is made by the Wonder service servers to the Apple iTunes™ music service in respect of the song title information to retrieve artist and album information in respect thereof. This information, once retrieved from the iTunes music service is stored in the Wonder service database, and in this implementation may be available for searching.

Use of the Wonder Service

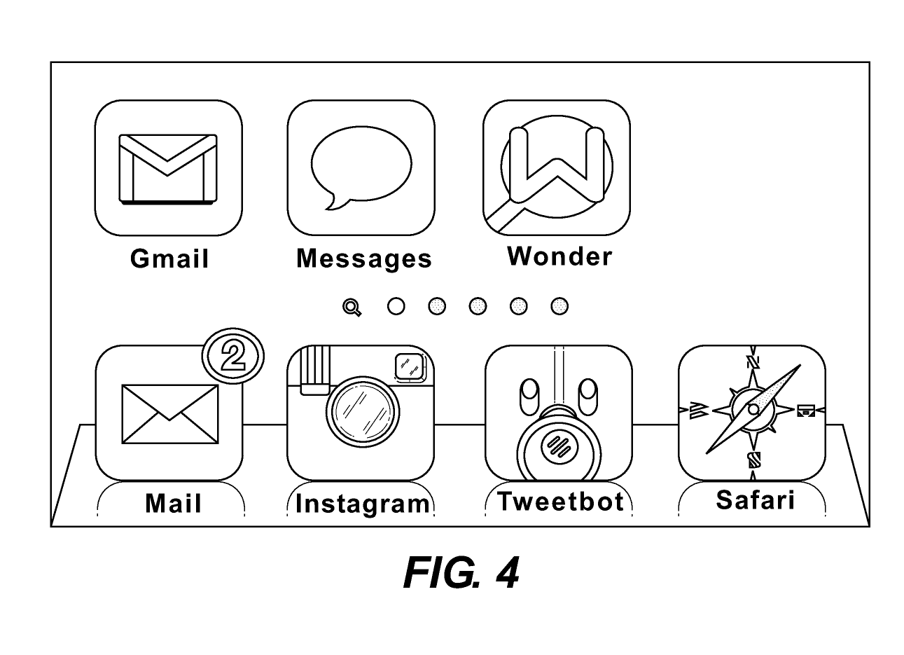

Keeping in mind the above description of the schematic of the Wonder service, use of the Wonder service will be now described. In FIG. 4, an icon representing the Wonder app is shown in a partial screen shot of an iPhone. As is standard on the iPhone, a touch screen forms part of the iPhone's user interface, and the Wonder app is accessed by pressing on the icon on the touch screen.

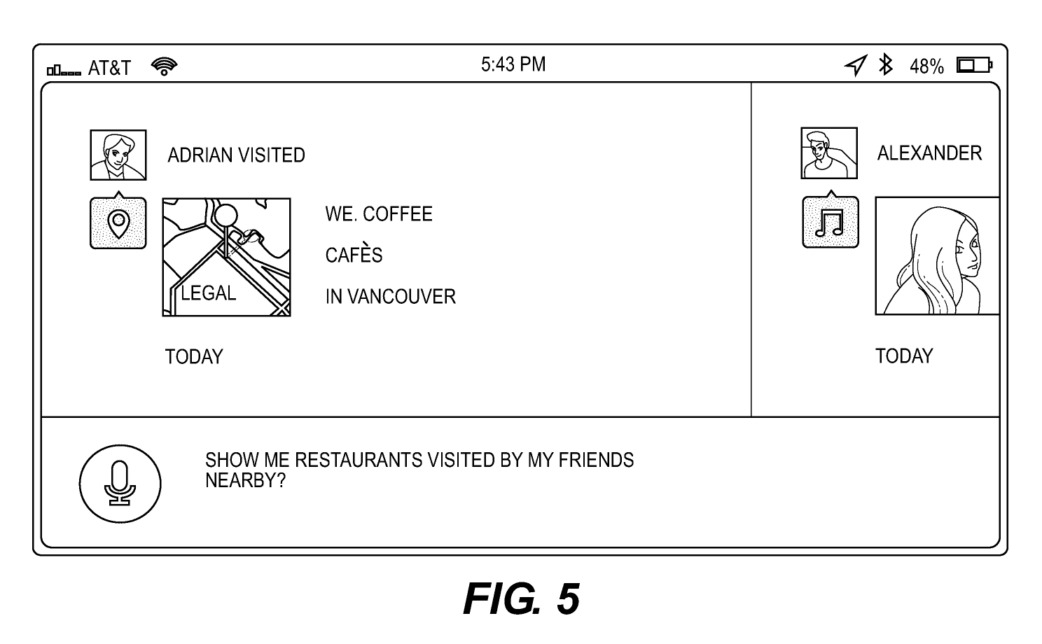

In FIG. 5, a screen shot of the Wonder app is shown. Provided on the screen is information in respect of users of social networking services (registered with the Wonder service) that have been indicated to be related to the registered user of the Wonder app on the iPhone in respect of the restaurants those users have visited.

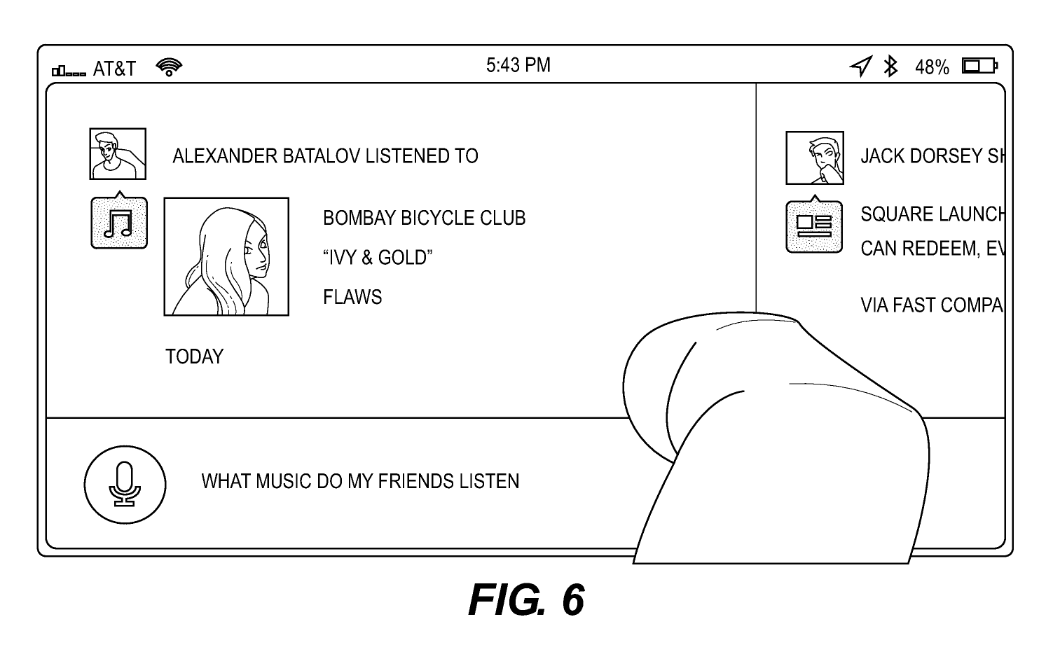

In FIG. 6, another screen of the Wonder app is shown. Provided on the screen is information in respect of users of social networking services (registered with the Wonder service) that have been indicated to be related to the registered user of the Wonder app on the iPhone in respect of the music those users have listened to. This screen has been accessed by the iPhone user having touched the iPhone screen and having slid their finger to the left (with respect to the image in FIG. 5).

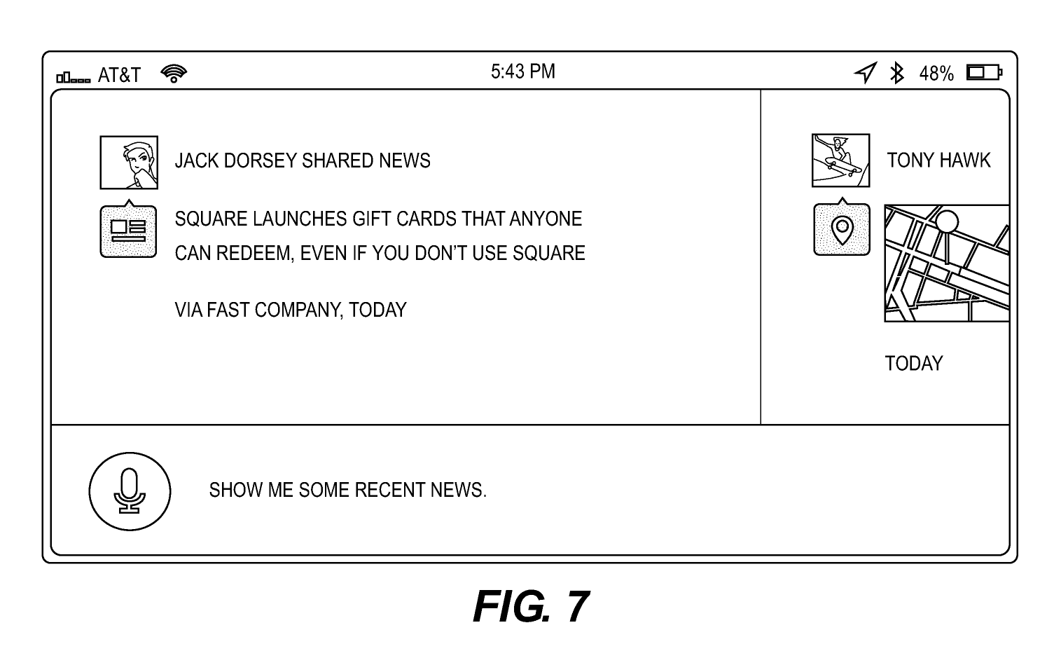

In FIG. 7, another screen of the Wonder app is shown. Provided on the screen is information in respect of users of social networking services (registered with the Wonder service) that have been indicated to be related to the registered user of the Wonder app on the iPhone in respect of the news those users have shared. This screen has been accessed by the iPhone user having touched the iPhone screen and having slid their finger to the left (with respect to the image in FIG. 6).

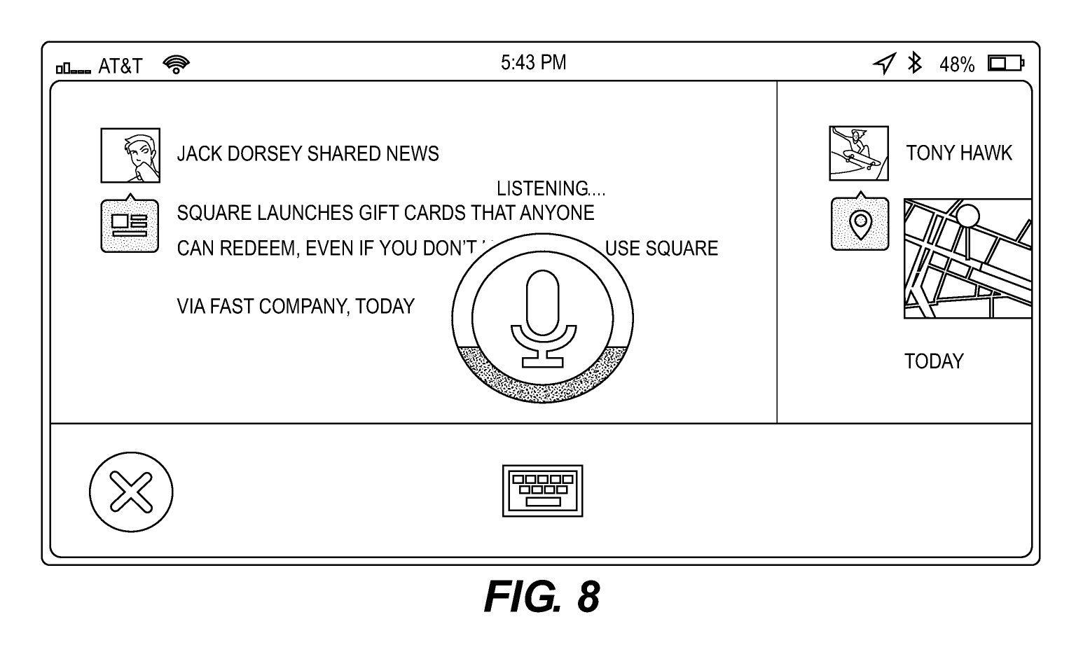

Showing in the bottom left corner of the screen in FIGS. 5-7 is a small blue button having the image of a microphone thereon. When pressed, this button activates a voice capture sub-process is activated allowing the user of the iPhone to speak a search query and have a search effected on a database of their “friends” social networking information as is described herein (as described in part above). Shown in FIG. 8 is a screen of the Wonder app when the blue button referred to has been pressed.

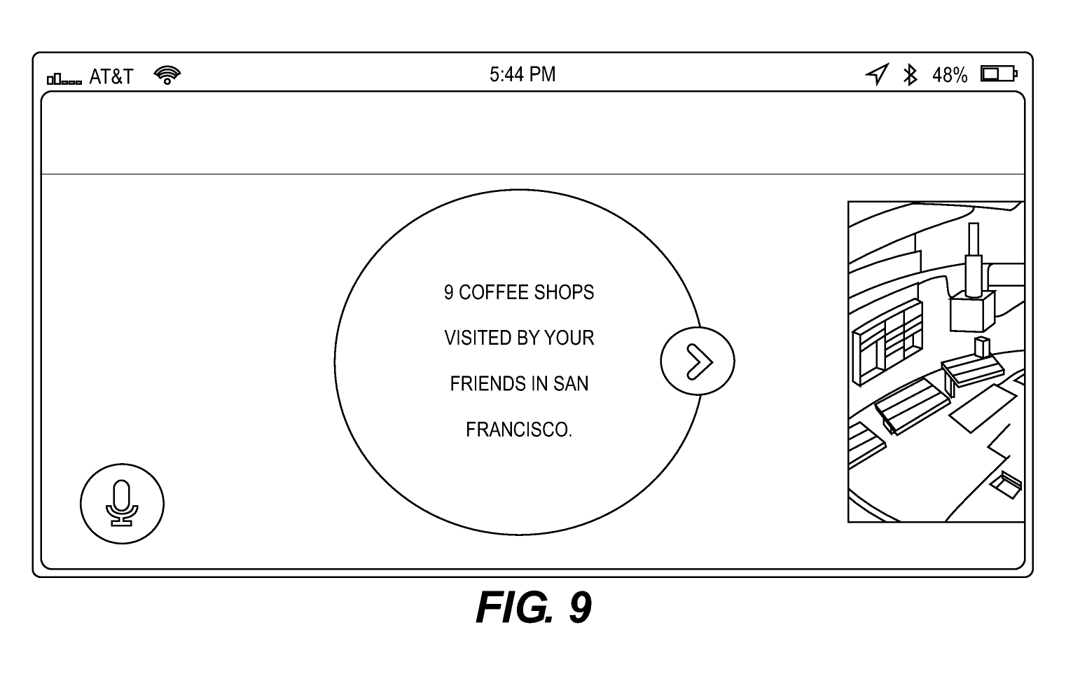

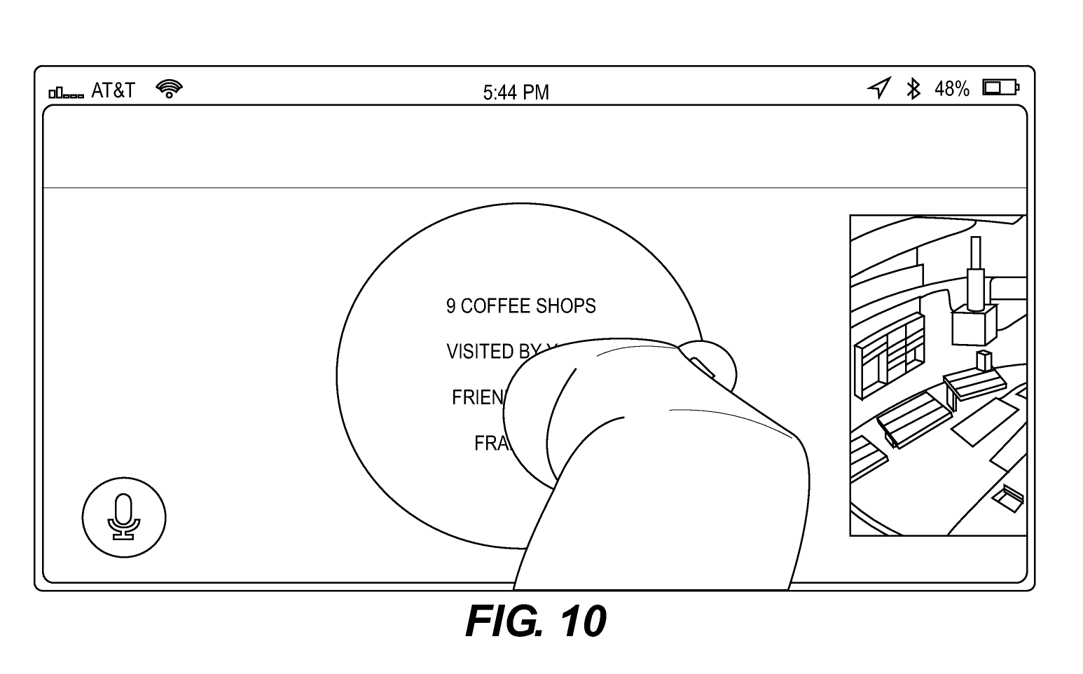

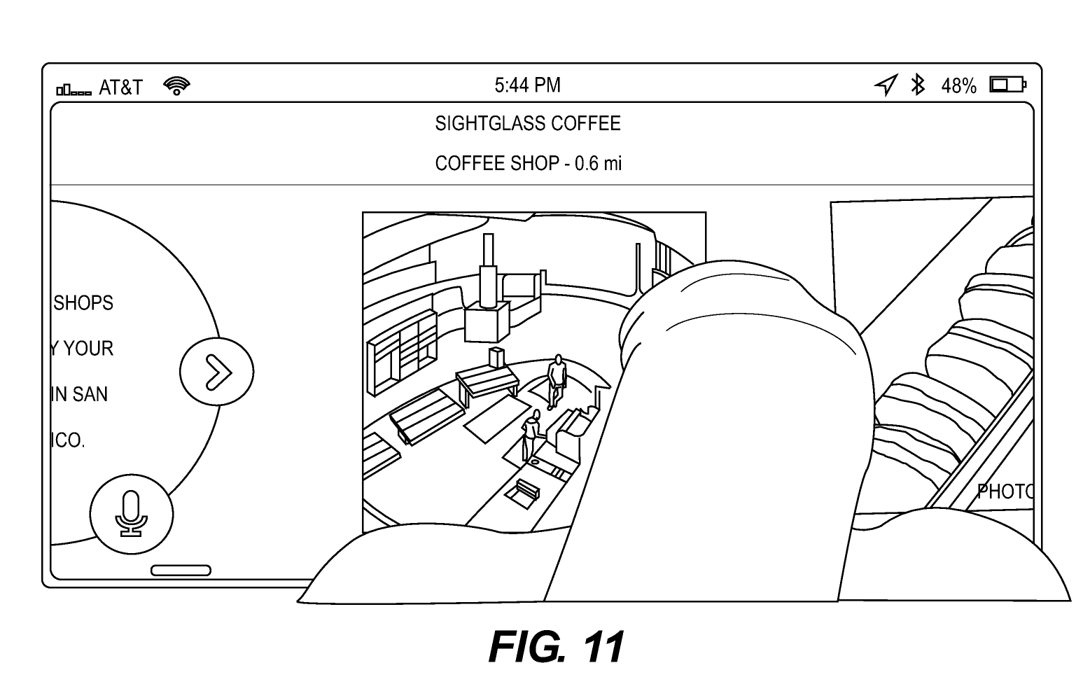

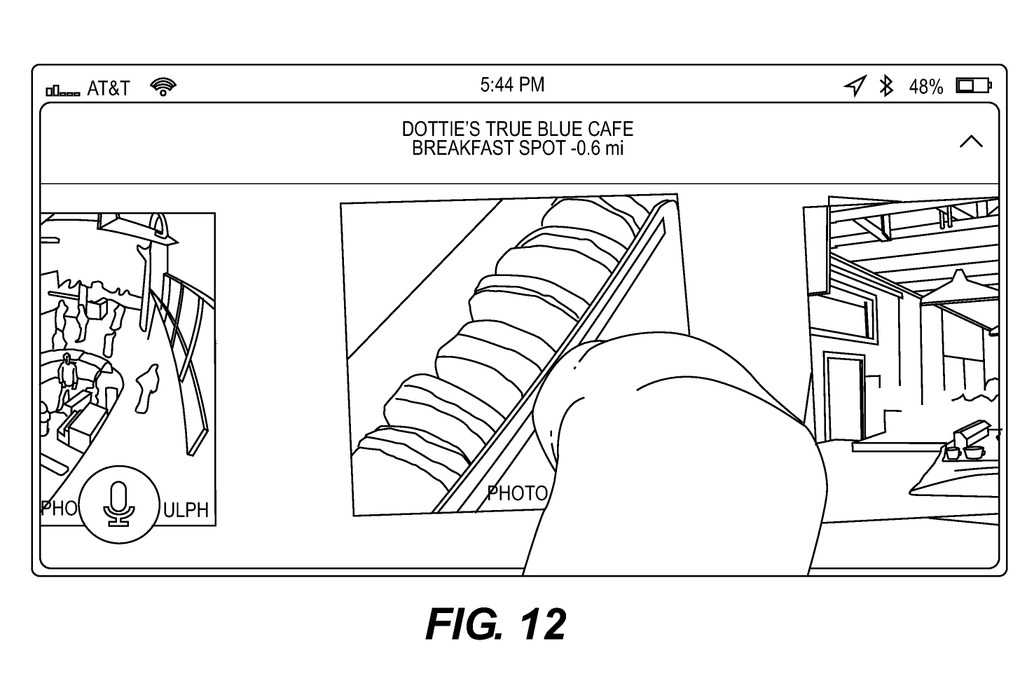

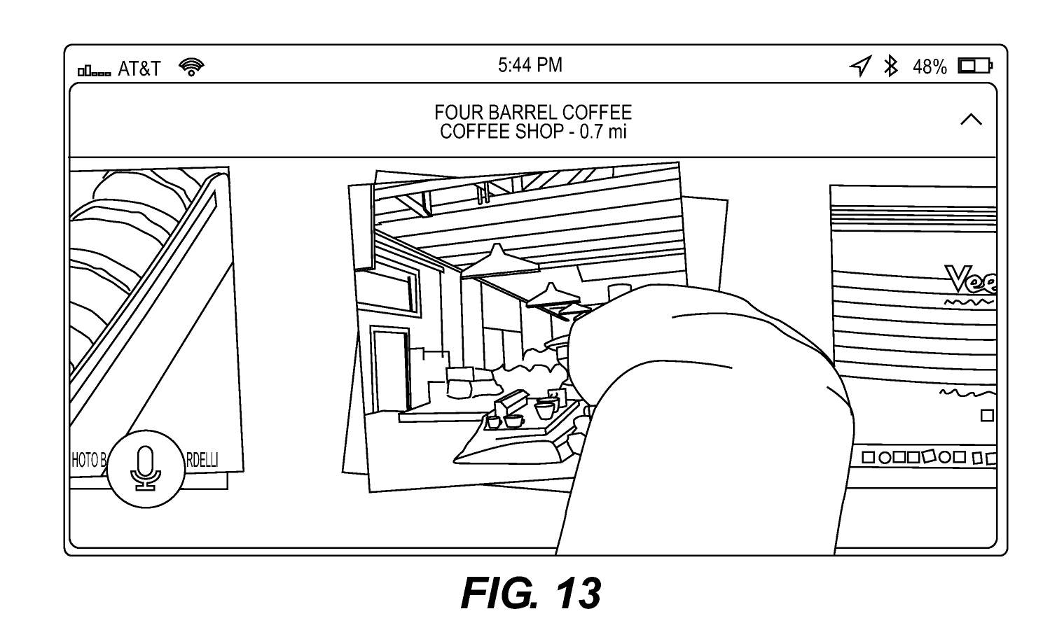

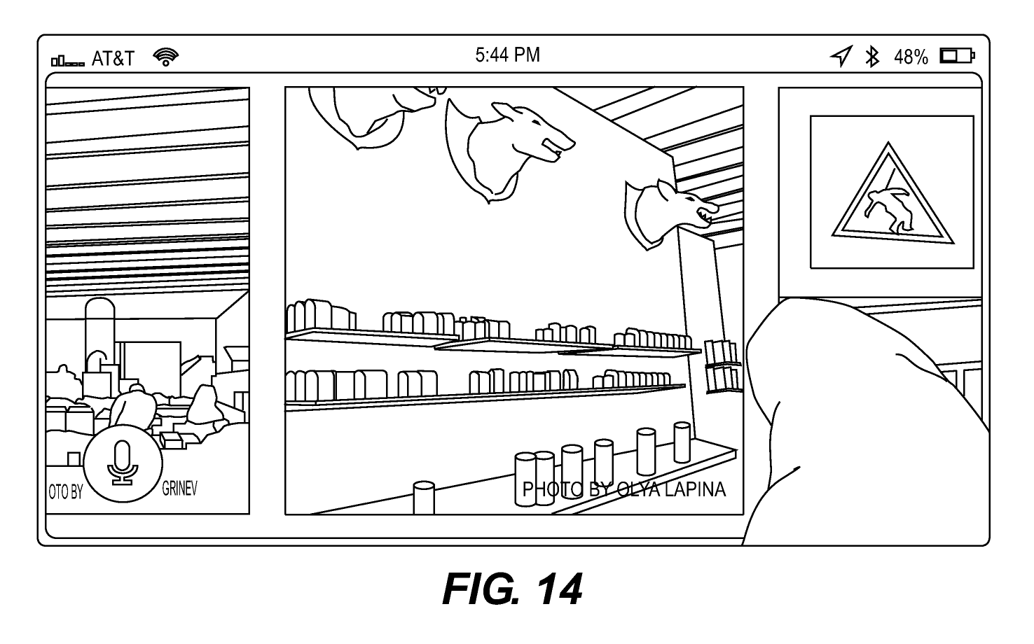

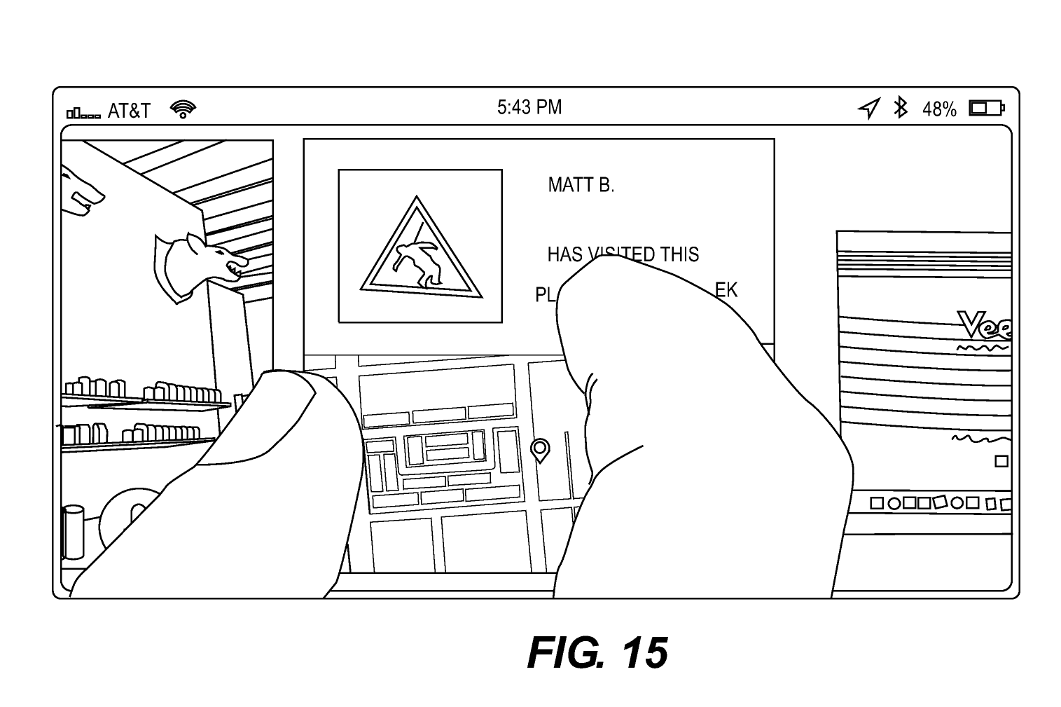

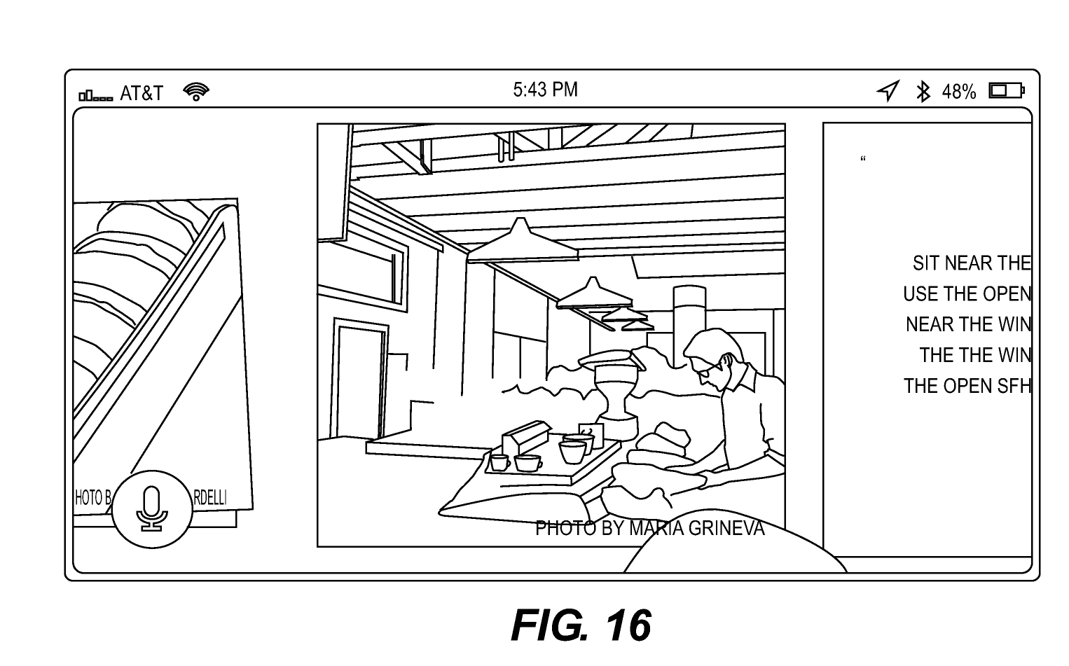

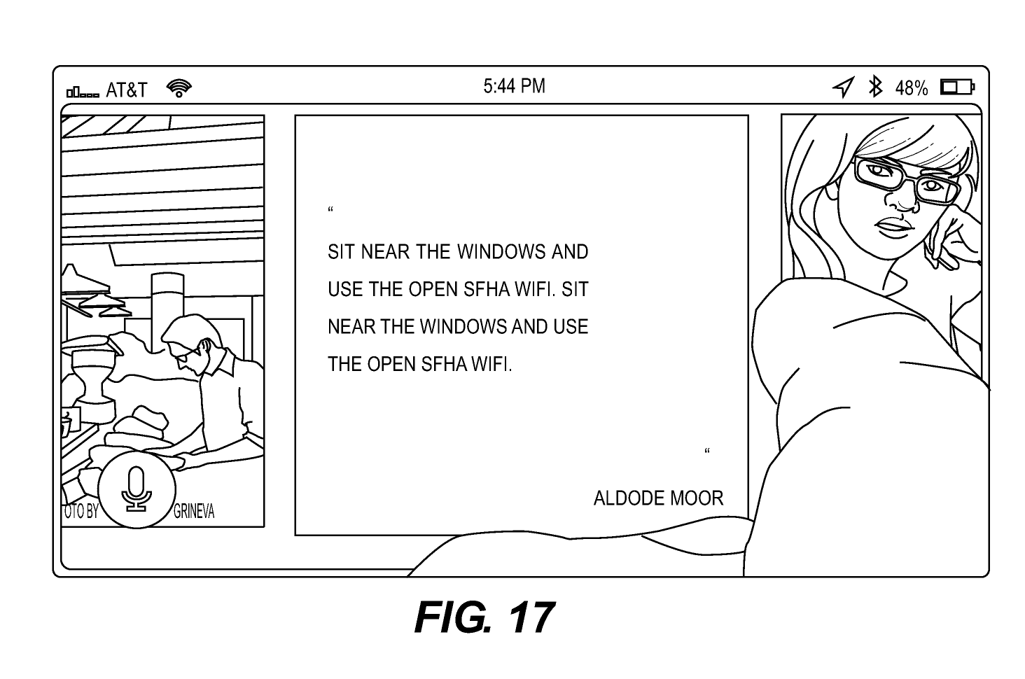

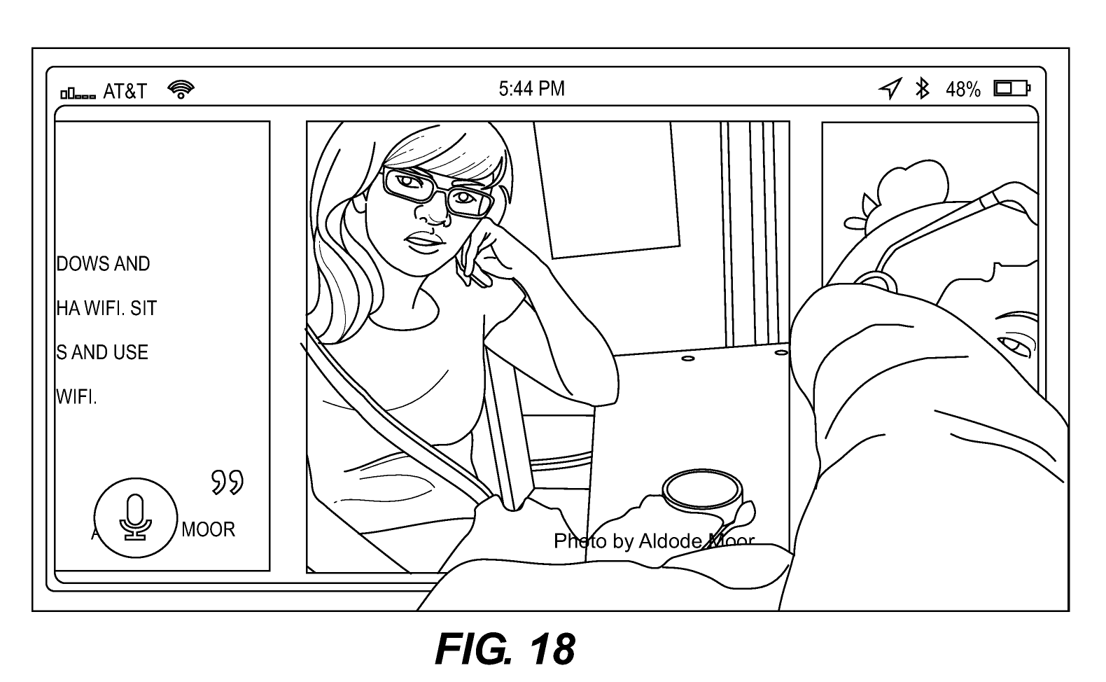

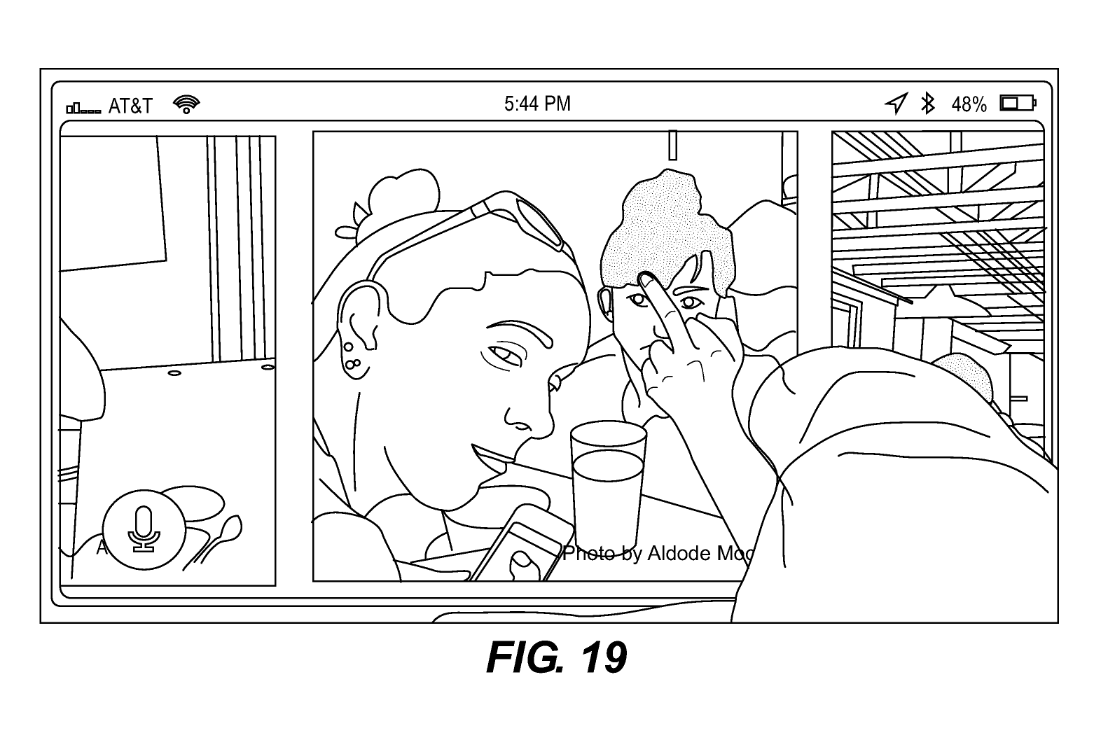

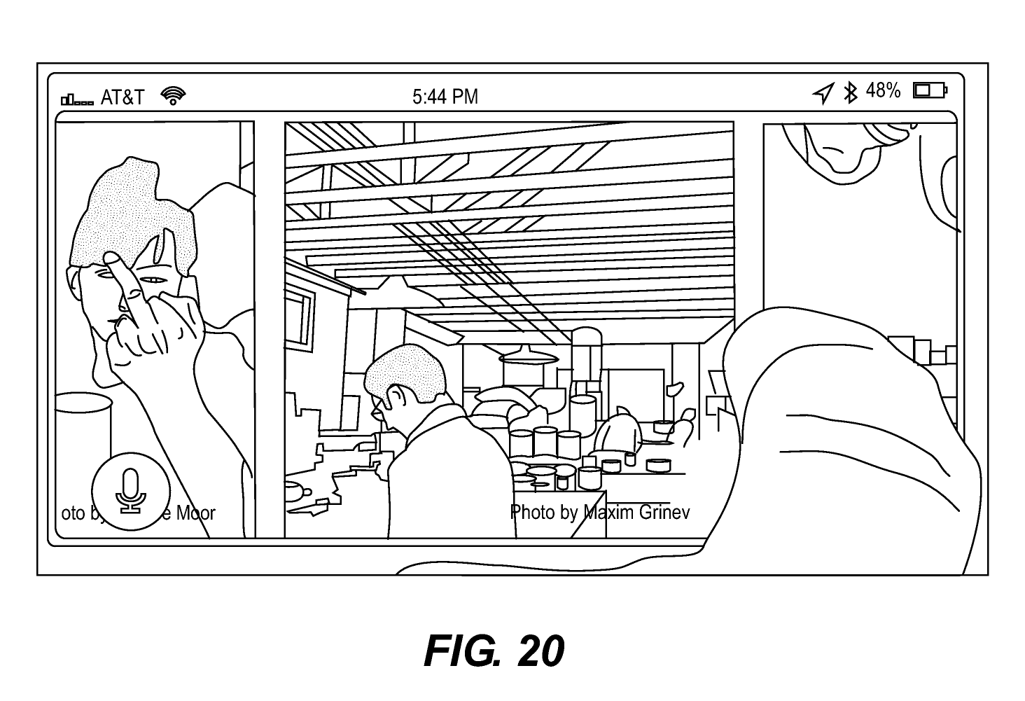

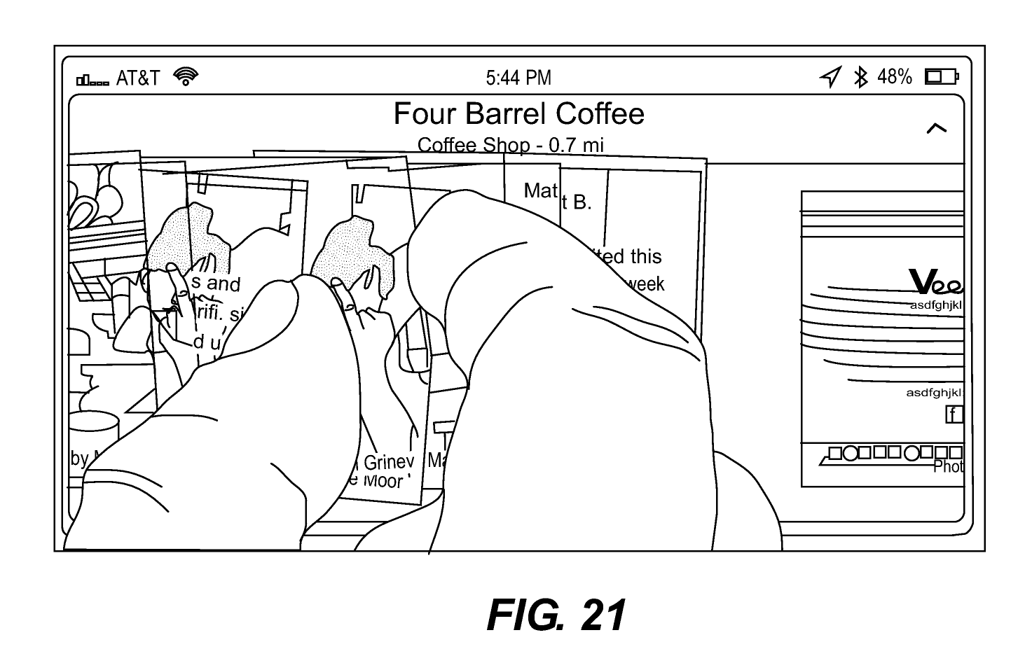

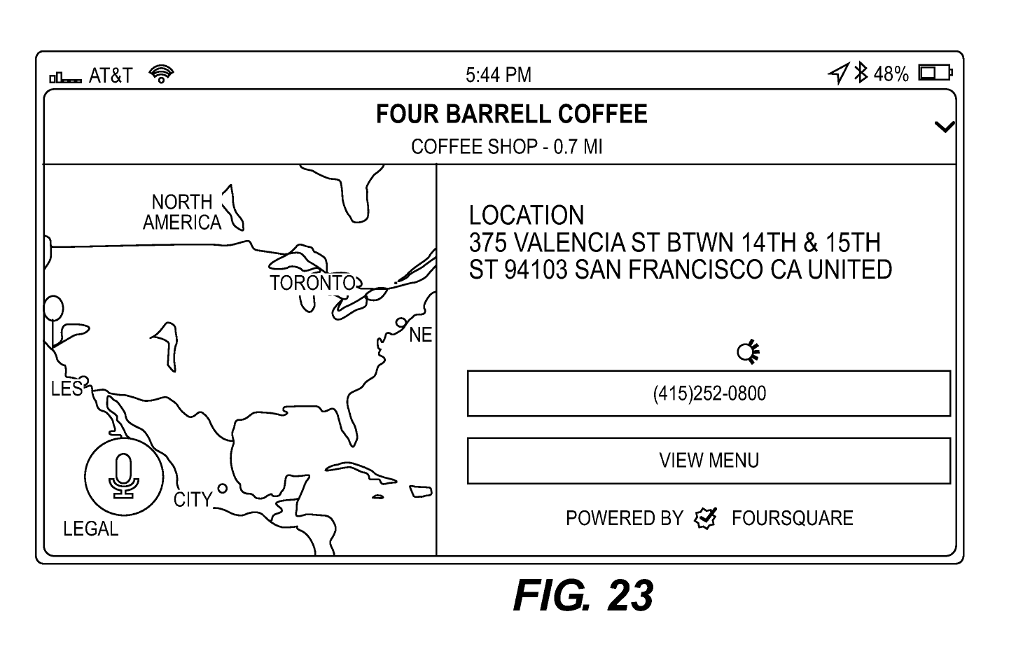

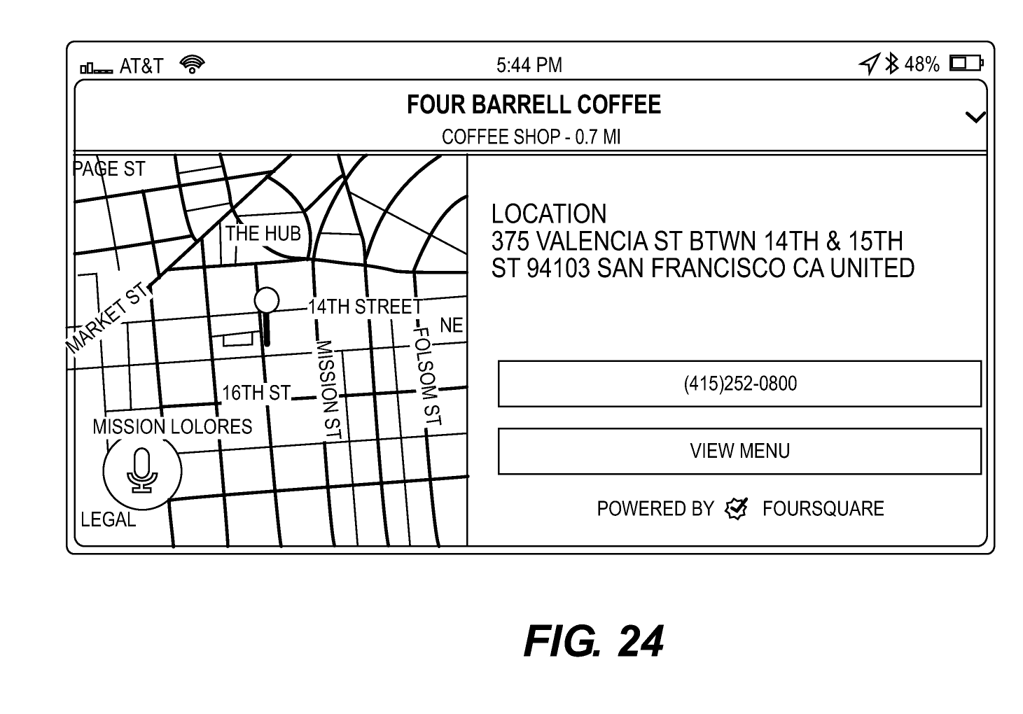

In FIG. 9, there is shown a screen of the wonder app with respect to the results of a search for the query “what coffee shops have my friends visited in San Francisco?” As can been seen in FIGS. 9 to 24 the search results of the query are displayed as a series of stacks of items of information (e.g. pictures, comments) with each stack representing a specific coffee shop being a result of the search. The user navigates amongst the stacks by swiping left and right on the screen. Above each stack is the name of the coffee shop in question (where the pictures were taken, about which the comments were made, etc.) as well as the then current distance of the location of the iPhone user to the coffee shop. As is also shown in the Figures, the user can expand the stack with respect to a particular search result by reverse pinching on the stack. This will expand the stack and the user can then swipe left or right to individually view the various items of the stack. The user can collapse the stack by pinching on the screen showing the individual stack items in a series layout.

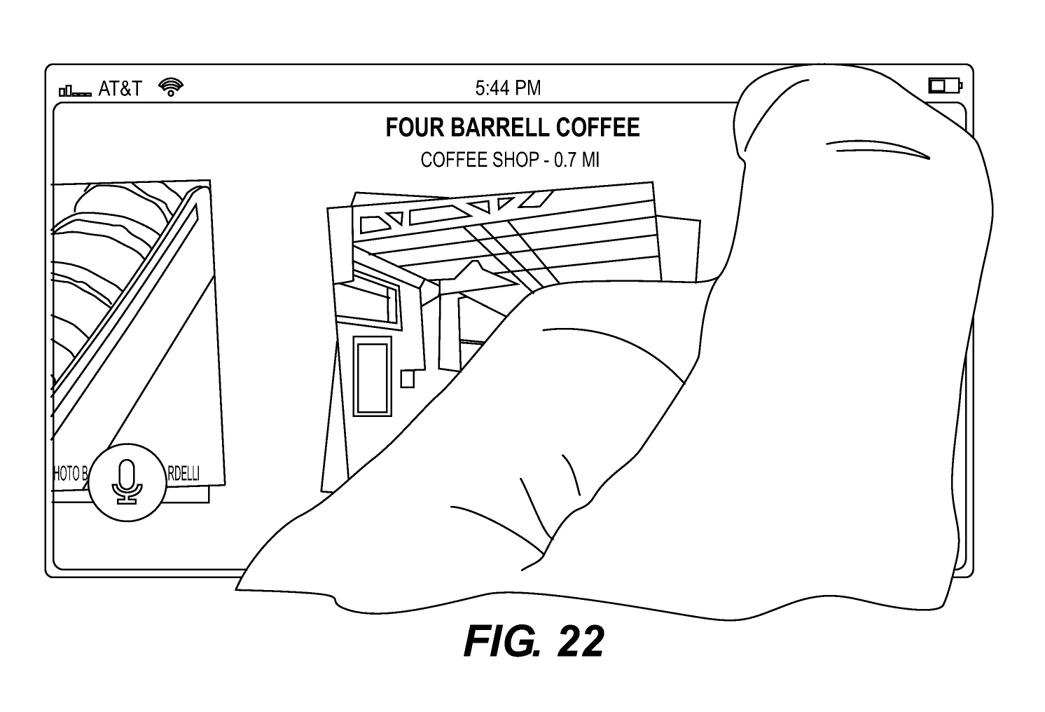

As is shown in FIGS. 22-24, if the user taps on the name of the search result (in this case a coffee shop), further information (e.g. map info, directions, and address) is displayed. Additional options are also provided (e.g. phone the coffee shop, see the coffee shop's menu—this information is not from a social networking service but rather is from an unrelated third party source—and in this implementation may be retrieved directly via the iPhone and not via the Wonder service servers).

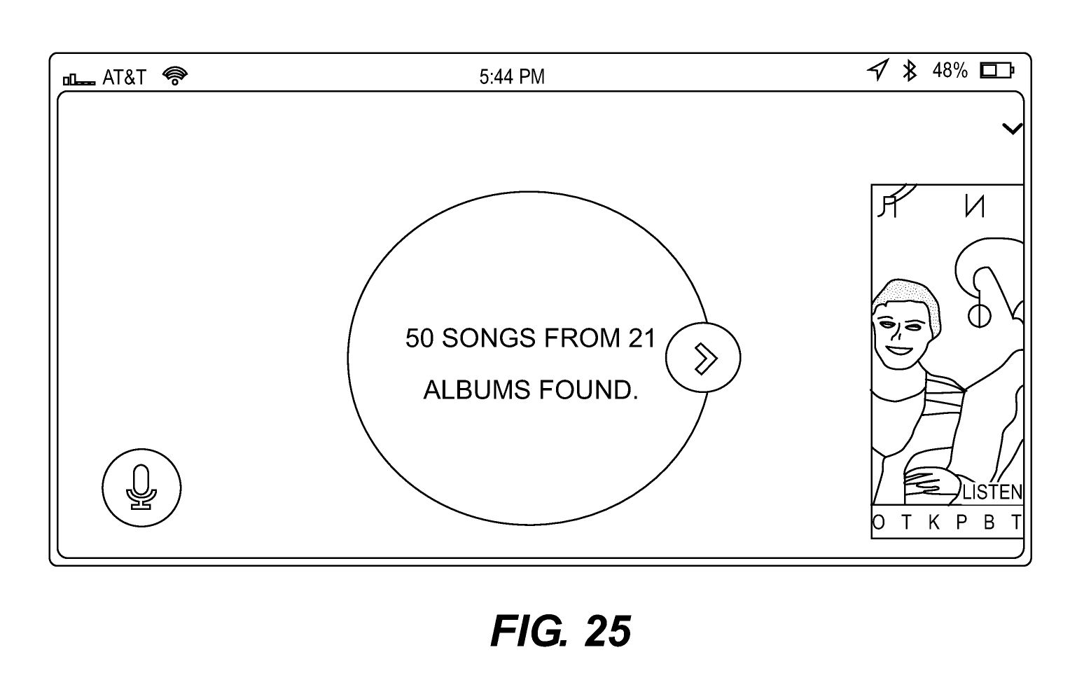

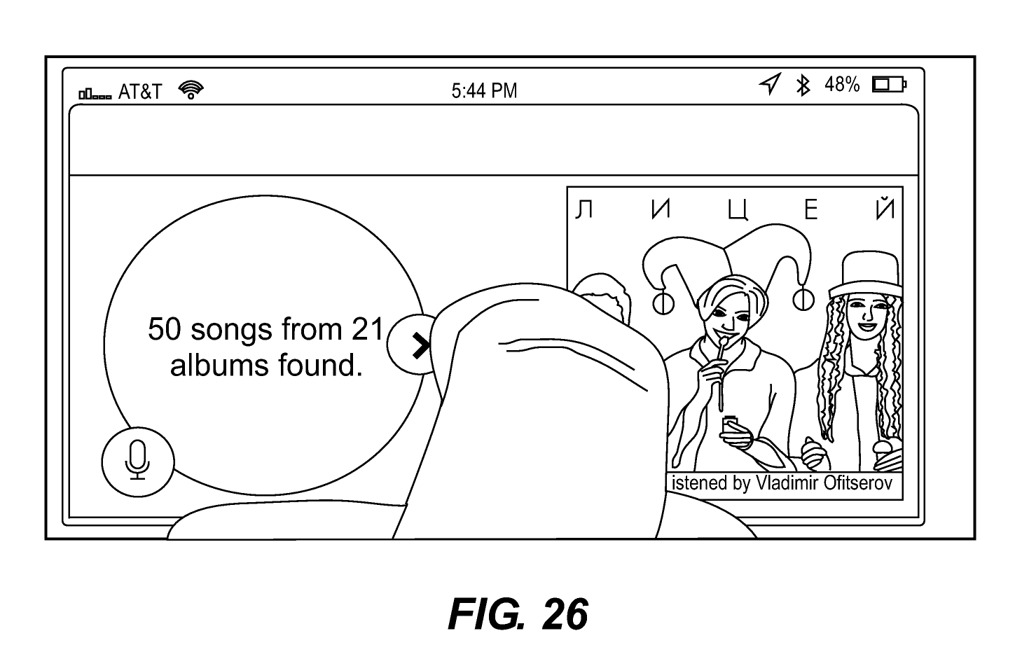

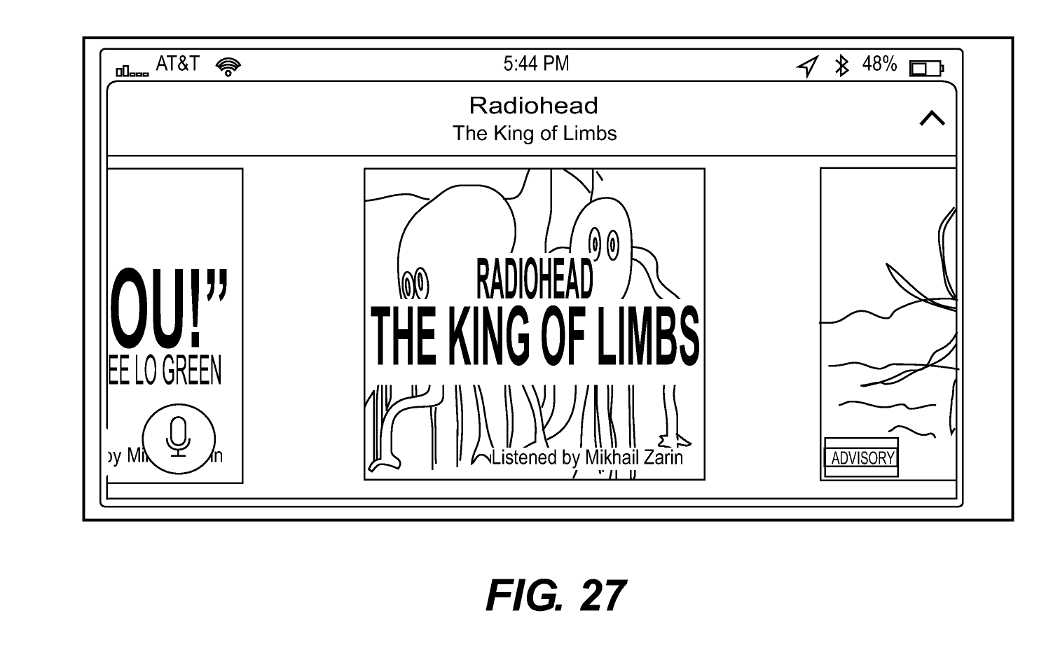

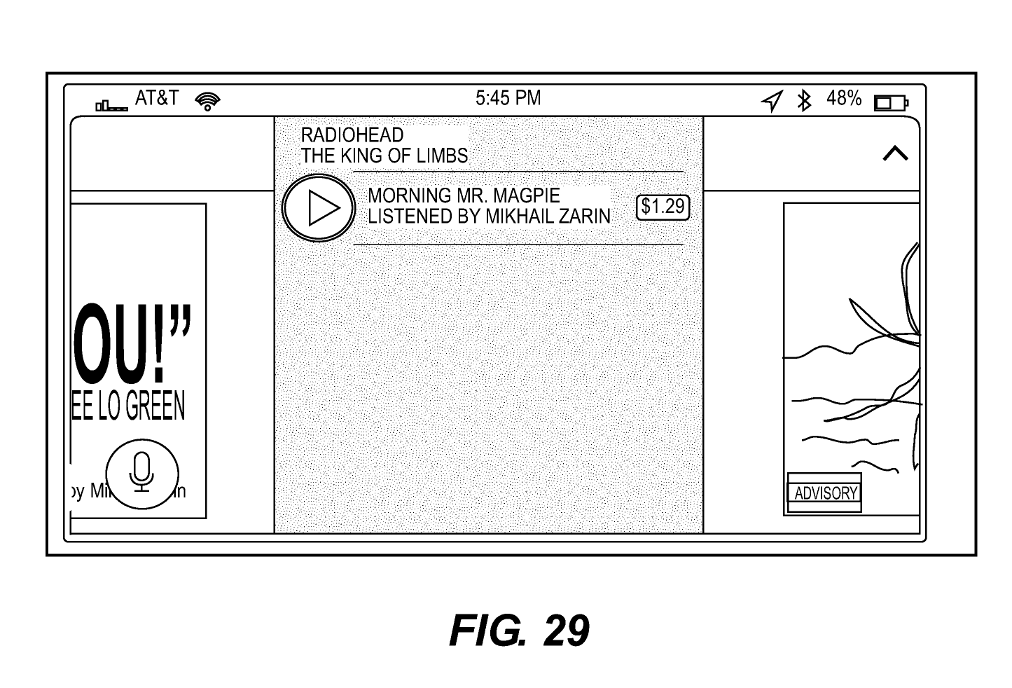

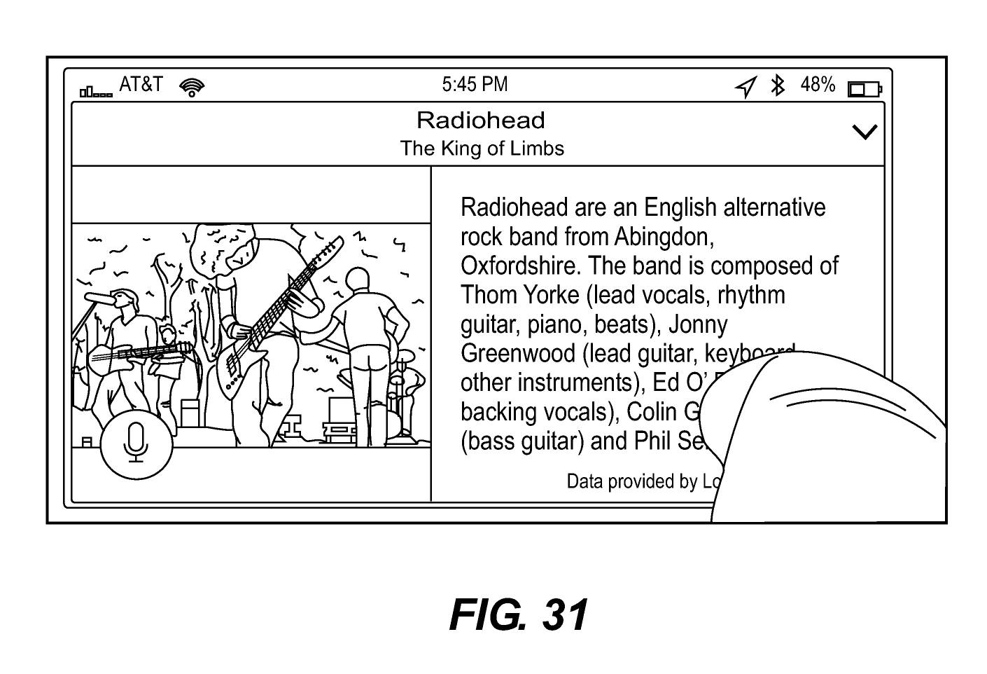

In FIG. 25, there is shown a screen of the Wonder app with respect to the results of a search for the query “what music have my friends listened to lately?” As can been seen in FIGS. 26 to 31 the search results of the query are displayed as a series of items of information (e.g. album cover artwork, individual song artwork, artist artwork) with each item representing specific music (be it a song or an album) being a result of the search. Above each item is the name of the music in question as well as the name of the artist. The user navigates amongst the items by swiping their finger left or right on the screen.

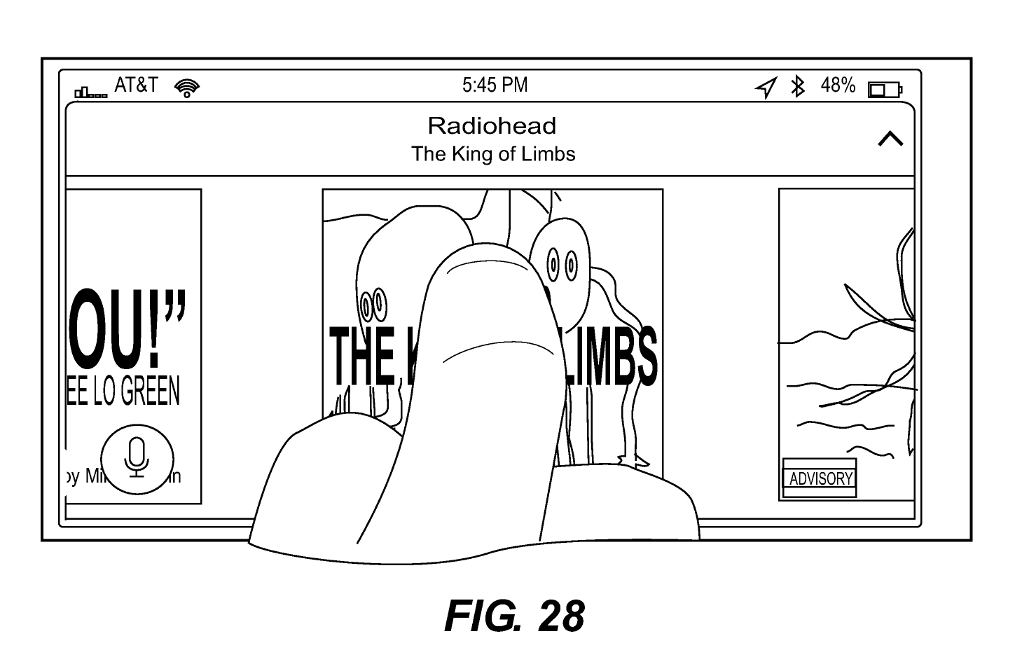

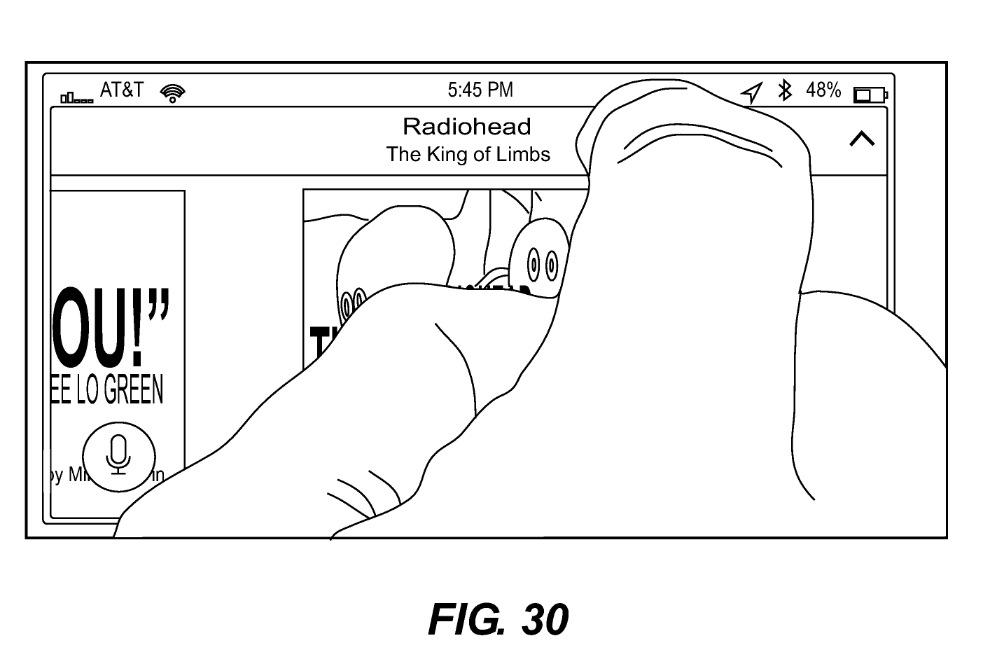

As is shown in FIGS. 28 & 29, if the user taps on the artwork associated with the music, they are presented with an opportunity to listen to or purchase the music via iTunes. As is shown in FIGS. 30 & 31, if the user taps on the name associated with the music, they are presented with further information about the artist (provided by an iTunes).

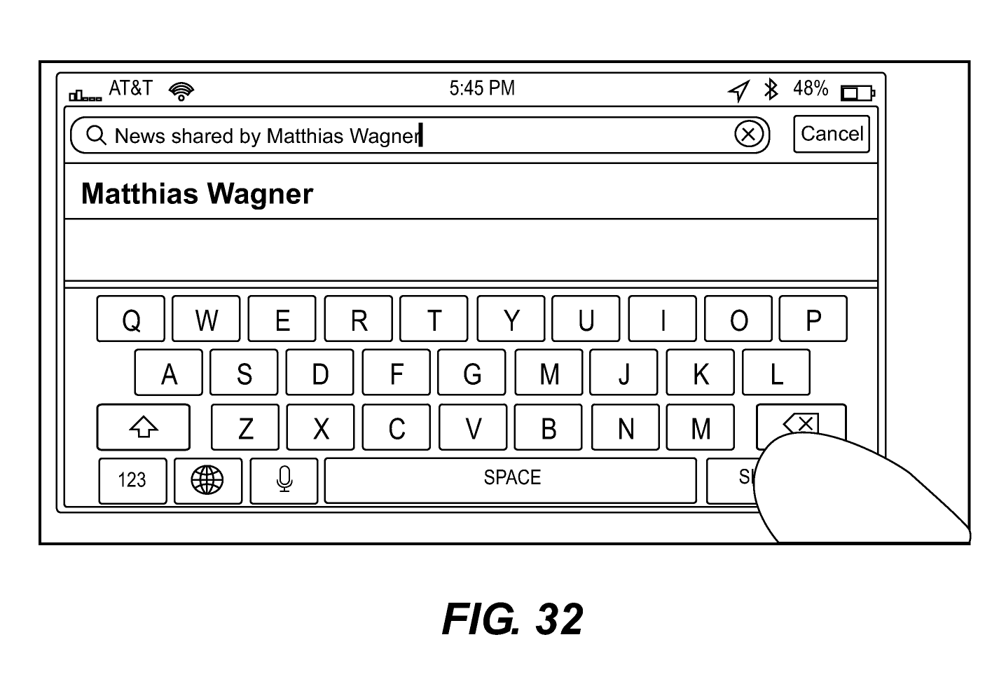

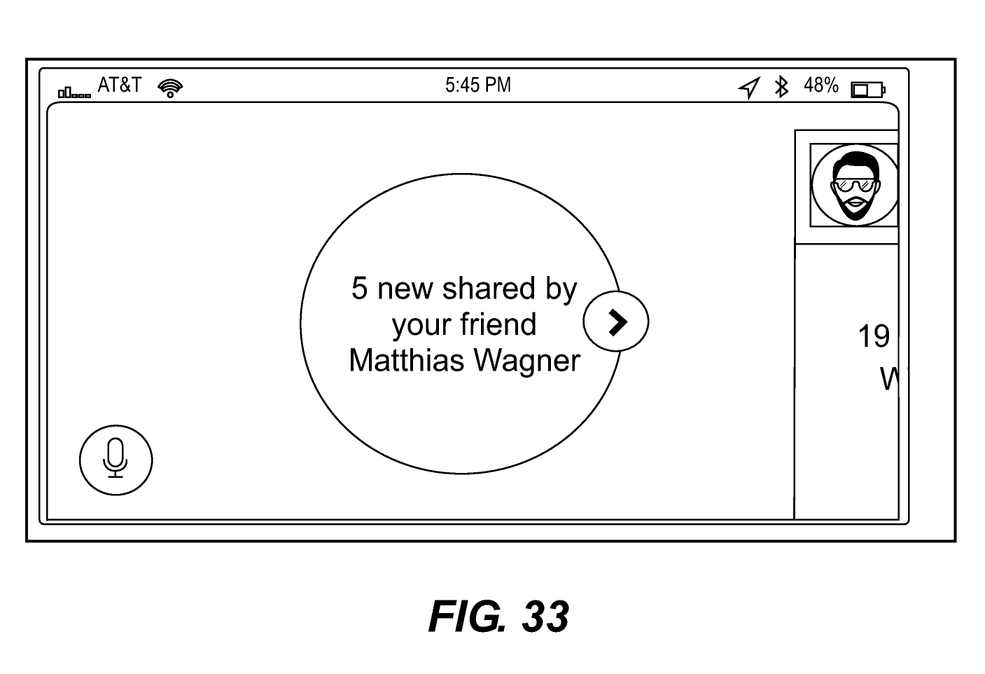

As is shown in FIG. 32, it is also possible for the user to input a search query via direct text input (as opposed to via voice). In that FIG. 32, the search query input by the user is with respect to “news shared by Matthias Wagner” (a Facebook “friend” of the user). In FIG. 33, there is shown a screen of the Wonder app with respect to the results of that search query.

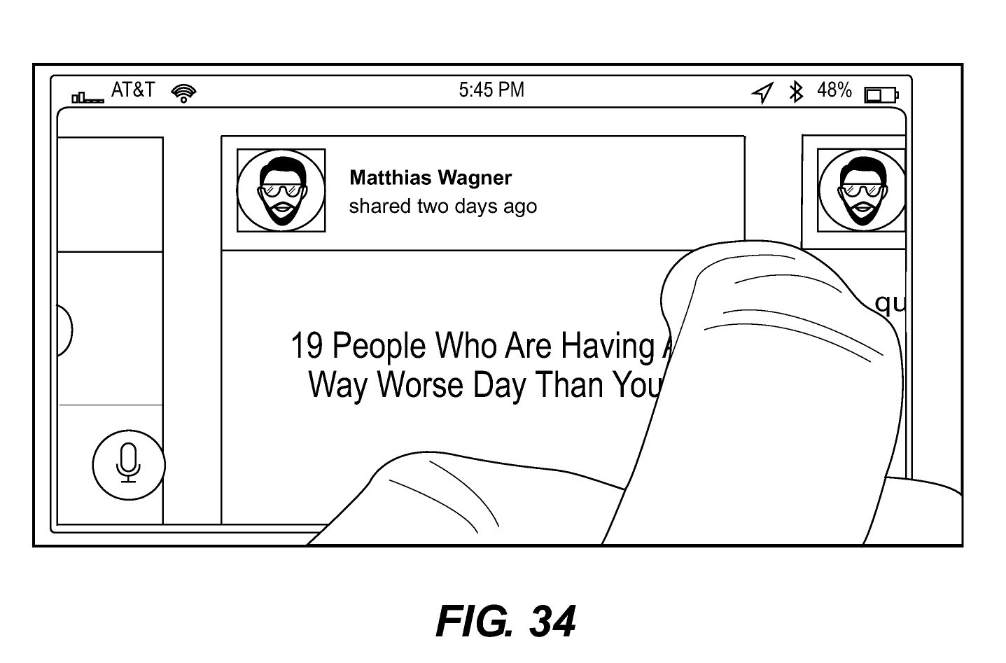

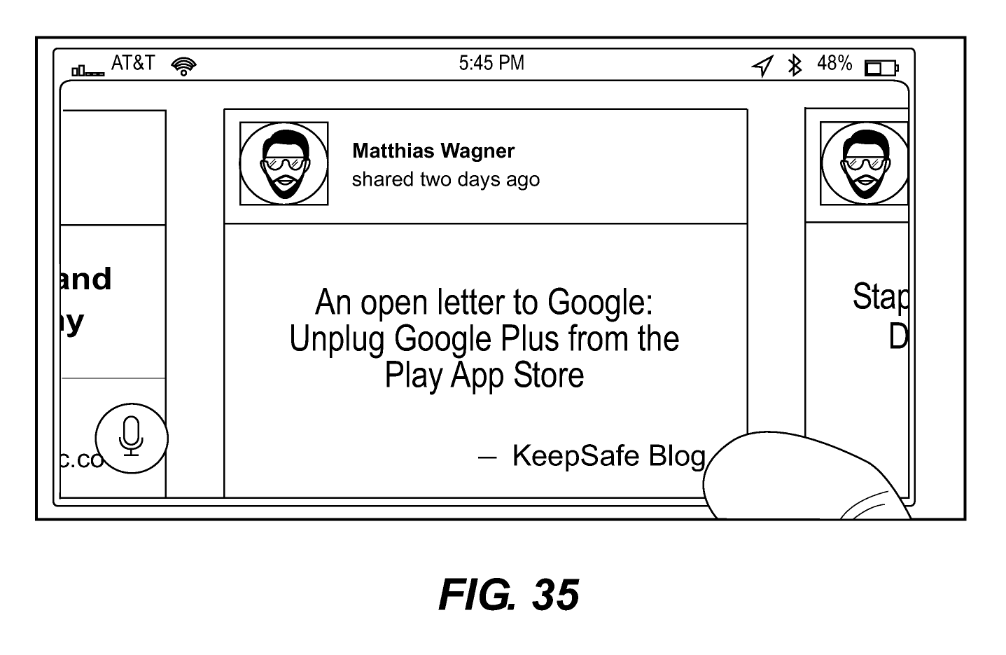

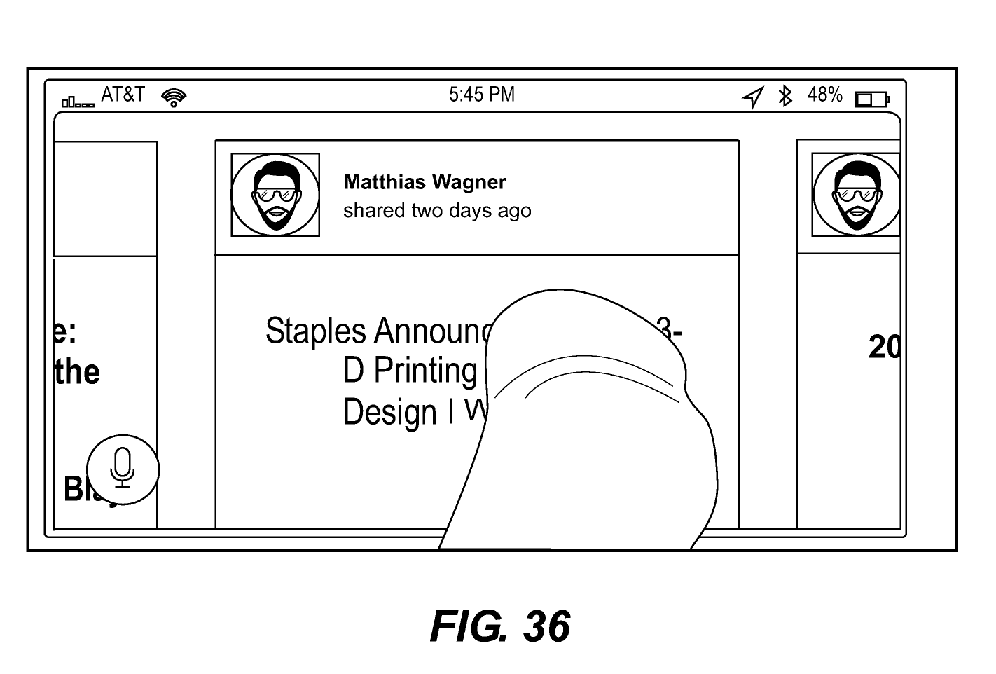

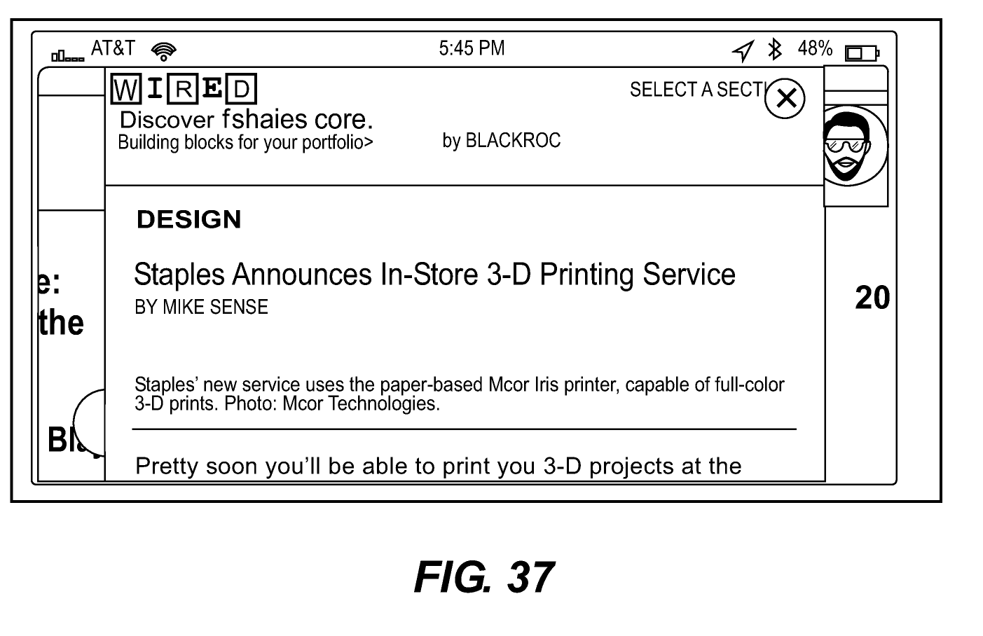

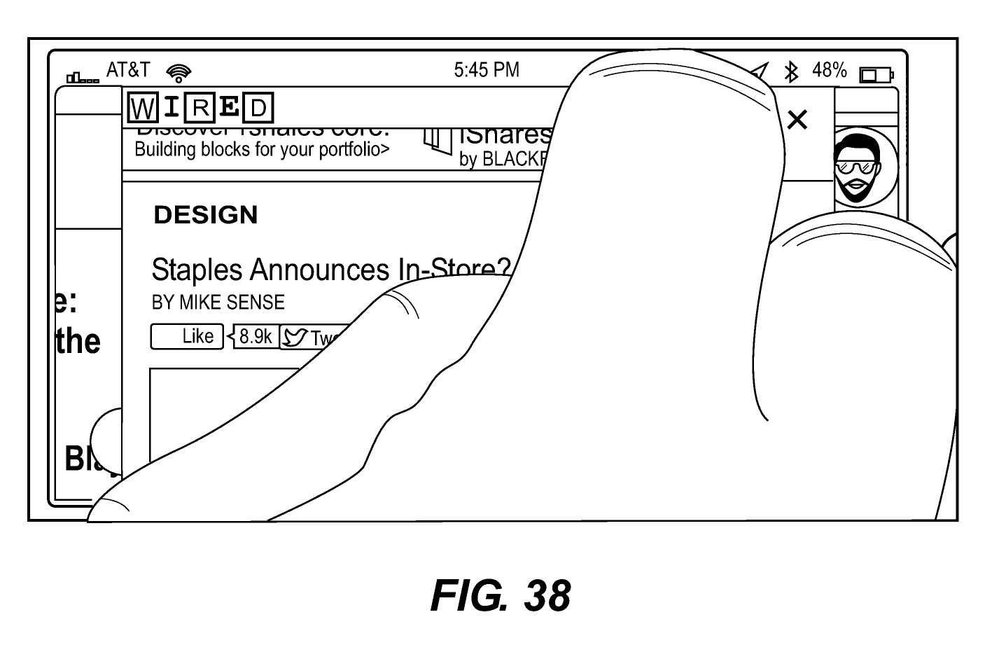

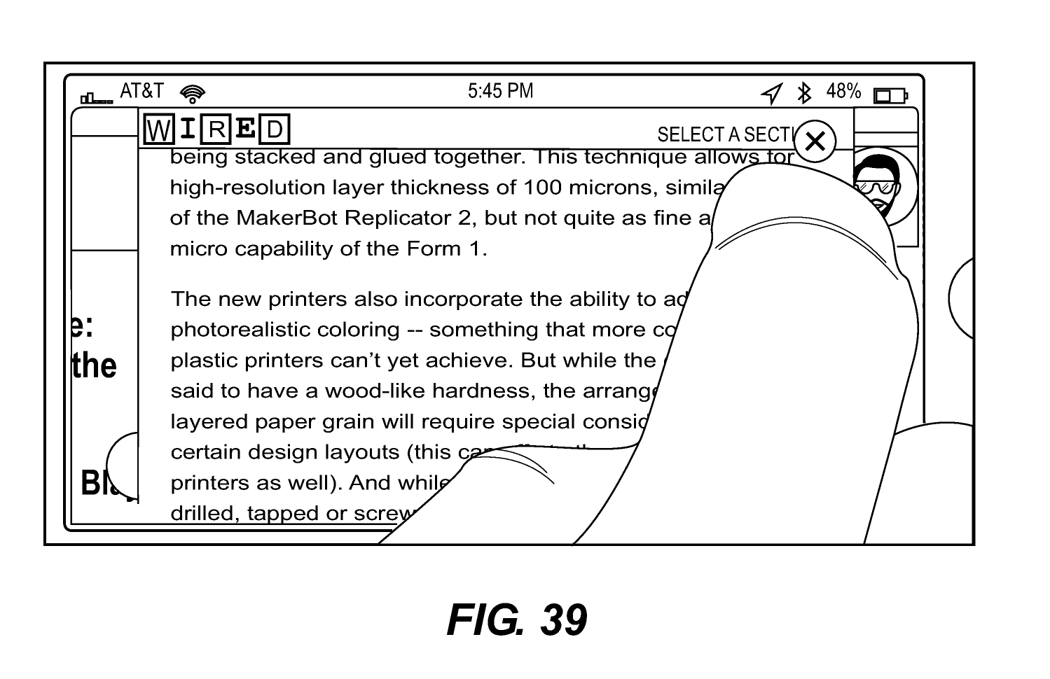

As can been seen in FIGS. 34 to 39, the search results of the query are displayed as a series of items of information with each item stack representing a specific news item being a result of the search. The user navigates amongst the items by swiping left and right on the screen. Above each item is further information about the person who shared the item and when the item was shared. As can also be seen in the Figures if the user taps on an item, a web browser integrated into the Wonder app is opened, the Wonder app enters into communications with the source of the item, and the news item itself is retrieved and displayed.

Specific Methods of the Present Implementation

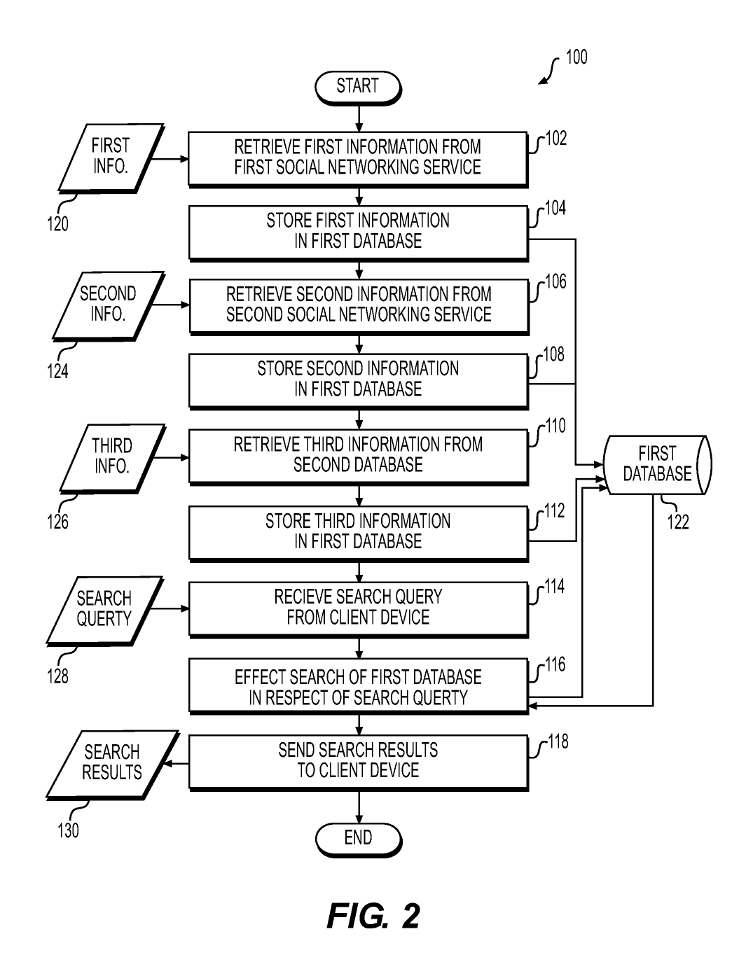

Keeping in mind the above description of the Wonder app and service described hereinabove, referring now to FIG. 2 there is shown an implementation of a method 100 of managing social networking information of a first user (e.g. a user of the Wonder app), of the present technology. Method 100 starts at 102 with retrieving from a first social networking service (e.g. from the Facebook social networking service), via at least one server (e.g. the Wonder service servers), first information 120 in respect of at least one second user of the first social networking service having been identified by the first user as related to the first user (e.g. the information available in the news feed of the Facebook networking service of the Wonder app user in respect of (at least) Facebook “friends” of the Wonder app user). At 104, the retrieved first information 120 is then stored in at least one first database 122 in operational communication with the at least one server (e.g. the Wonder service database). At 106, second information 124 (e.g. the Twitter service feed) in respect of at least one third user having been identified by the first user as related to the first user (e.g. a person that the Wonder app user is following on the Twitter social network service) is retrieved from a second social networking service (e.g. the Twitter social networking service), via the at least one server (e.g. the Wonder service servers). At 108, the retrieved second information 124 is stored in the at least one first database 122 in operational communication with the at least one server (e.g. the Wonder service database). At 110, third information 126 related to at least one of the first information and the second information (e.g. the artistic and album information of a song mentioned in either of the first information or second information) is retrieved from a second database operationally unrelated to the first social networking service and the second networking service (e.g. the Apple iTunes music service), via the at least one server (e.g. the Wonder service servers). At 112, the third information 126 is stored in the at least one first database 122 (e.g. the Wonder service database). At 114, a search query 128 is received, via the at least one server (e.g. the Wonder service servers), from a client device of the first user (e.g. via the Wonder app in operation on the iPhone of the iPhone user). At 116, a search of the at least first one database 122 (e.g. the Wonder service database) in respect of the search query 128 is effected via the at least one server (e.g. by the mySQL relational database management system). At 118, results 130 of the search are sent to the client device of the first user (e.g. the Wonder app on the iPhone of the iPhone user), via the at least one server (e.g. the Wonder service servers).

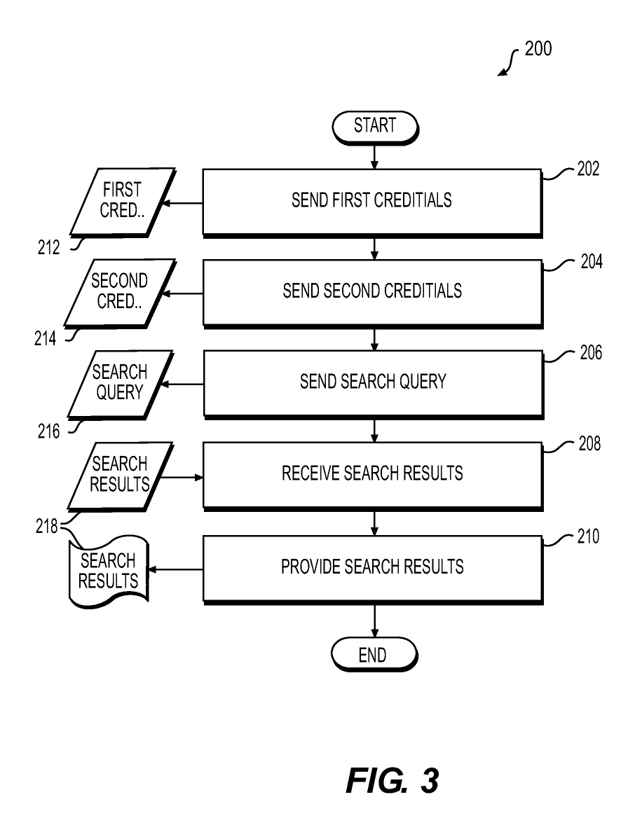

Referring now to FIG. 3, there is shown an implementation of a method 200 of managing social networking information of a first user (e.g. a user of the Wonder app), of the present technology. Method 200 starts at 202, with sending from a client device (e.g. the iPhone on which the Wonder app is running) to at least one server (e.g. the Wonder service servers), first credentials 212 of the first user (e.g. the user's Facebook login information—e.g. email and password) with respect to a first social networking service (e.g. the Facebook social networking service). At 204, second credentials 214 of the first user (e.g. the user's Twitter login information—e.g. email and password) with respect to a second social networking service (e.g. the Twitter social networking service) are sent from the client device (e.g. the iPhone) to the at least one server (e.g. the Wonder service servers). At 206, a search query 216 in respect of first information having been received from the first social networking service (e.g. the Facebook social networking service) in respect of at least one second user having been identified by the first user as related to the first user (e.g. the information available in the news feed of the Facebook networking service of the Wonder app user in respect of (at least) Facebook “friends” of the Wonder app user) and in respect of second information (e.g. the Twitter service feed) having been received from the second social networking service (e.g. the Twitter social networking service) in respect of at least one third user having been identified by the first user as related to the first user (e.g. a person that the Wonder app user is following on the Twitter social network service) is sent from the client device (e.g. the iPhone running the Wonder app) to the at least one server (e.g. the Wonder service servers). At 208, results 218 of a search having been effected in respect of the search query on the first information and the second information are received by the client device (e.g. the iPhone running the Wonder app) from the at least one server (e.g. the Wonder service servers). At 210, the first user (e.g. the user of the Wonder app) is provided with the search results 218 via a user interface of the client device (e.g. the screen of the iPhone).

Modifications and improvements to the above-described implementations of the present technology may become apparent to those skilled in the art. The foregoing description thereof is intended to be exemplary rather than limiting. The scope of the present invention is intended to be limited solely by the scope of the appended claims.

1. A method for managing social networking service information of a first user, comprising:
retrieving from a first social networking service, via at least one server, first information in respect of at least one second user of the first social networking service having been identified by the first user as related to the first user;
storing the retrieved first information in at least one first database in operational communication with the at least one server, without creating a new social networking service or extending an existing social networking service;
retrieving from a second social networking service, via the at least one server, second information in respect of at least one third user having been identified by the first user as related to the first user;
storing the retrieved second information in the at least one first database in operational communication with the at least one server, without creating a new social networking service or extending an existing social networking service;
receiving, via the at least one server, a search query from a client device of the first user;
effecting a search of the at least first one database in respect of the search query via the at least one server; and
sending, via the at least one server, results of the search to the client device of the first user.

2. The method of claim 1, wherein retrieving from a first social networking service, via at least one server, first information in respect of at least one second user having been identified by the first user as related to the first user includes retrieving information from a news feed of the first user on the first social networking service on a first periodic basis.

3. The method of claim 1, wherein retrieving from a first social networking service, via at least one server, first information in respect of at least one second user having been identified by the first user as related to the first user includes retrieving information from the first social networking service via an API of the first social networking service on a second period basis.

4. The method of claim 1, wherein the first social networking service and the second social networking service are operationally unrelated to each other.

5. The method of claim 1, wherein at least one of the at least one second user and at least one of the at least one third user is the same user.

6. The method of claim 1, further comprising, retrieving from a second database operationally unrelated to the first social networking service and the second social networking service, via the at least one server, third information related to at least one of the first information and the second information.

7. The method of claim 6, further comprising storing the retrieved third information in the at least one first database.

8. A method for managing social networking service information of a first user, comprising:
sending from at least one client device to at least one server, first credentials of the first user with respect to a first social networking service;
sending from the at least one the client device to the at least one server, second credentials of the first user with respect to a second social networking service;
sending from the at least one client device to the at least one server, a search query in respect of first information having been received from the first social networking service in respect of at least one second user having been identified by the first user as related to the first user and in respect of second information having been received from the second social networking service in respect of at least one third user having been identified by the first user as related to the first user, without having created a new social networking service or having extended an existing social networking service; and
receiving by the at least one client device from the at least one server, results of a search having been effected in respect of the search query on the first information and the second information; and
providing the first user with the search results via a user interface of the at least one client device.

9. The method of claim 8, wherein the first social networking service and the second social networking service are operationally unrelated to one another.

10. The method of claim 8, wherein at least one of the at least one second user and at least one of the at least one third user is the same user.

11. The method of claim 8, wherein the search has also been effected on third information having been received from a second database operationally unrelated to the first social networking service and the second social networking service, the third information being related to at least one of the first information and the second information.

12. The method of claim 8, wherein the user interface of the at least one client device includes a screen, the search results appear on the screen as at least a user-navigable series of stacks, and a visual attribute of each stack provides an indication to the first user of a relative amount of the search results in that stack.

13. The method of claim 8, wherein the user interface of the at least one client device includes a screen and the search appears on the screen as at least user-navigable series of items, and the method further comprises providing the first user with additional information in respect of an item of the search results upon the first user gesturing on the screen of the client device.

14. The method of claim 13, further comprising, prior to providing the user with the additional information, retrieving the additional information, by the client device, other than via the search in respect of the search query.

15. A computer system for managing social networking service information of a first user, comprising:
at least one data retrieval component that retrieves from a first social networking service first information in respect of at least one second user of the first social networking service having been identified by the first user as related to the first user, and that retrieves from a second social networking service section information in respect of at least one third user of the second social networking service having been identified by the first user as related to the first user;
at least one data storage component that stores the retrieved first information and the retrieved second information in a first database, without creating a new social networking service or extending an existing social networking service;
a search query reception component that receives a search query from a client device of the first user;
a search effecting component that effects a search of at least the first database in respect of the search query; and
a search result dispatch component that sends results of the search to the client device of the first user.

16. The computer system of claim 15, wherein the at least one data retrieval component retrieves information from a news feed of the first user on the first social networking service on a first periodic basis.

17. The computer system of claim 15, wherein the at least one data retrieval component retrieves information from the first social networking service via an API of the first social networking service on a second period basis.

18. The computer system of claim 15, wherein the first social networking service and the second social networking service are operationally unrelated to each other.

19. The computer system of claim 15, wherein at least one of the at least one second user and at least one of the at least one third user is the same user.

20. The computer system of claim 15, further comprising a third data retrieval component that retrieves third information from a second database operationally unrelated to the first social networking service and the second social networking service, the third information related to at least one of the first information and the second information.

21. The computer system of claim 20, wherein the at least one data storage component stores the retrieved third information in the at least one first database.

22. A computer system for managing social networking service information of a first user, comprising:
a credentials dispatch component that sends via a communications network at least first credentials of the first user with respect to a first social networking service and second credentials of the first user with respect to a second social networking service;
a search query dispatch component that sends via the communications network a search query in respect of first information having been received from the first social networking service in respect of at least one second user having been identified by the first user as related to the first user, without a new social networking service having been created or an existing social networking service having been extended, and in respect of second information having been received from the second social networking service in respect of at least one third user having been identified by the first user as related to the first user, without a new social networking service having been created or an existing social networking service having been extended; and
a search result reception component that receives via the communications networking results of a search having been effected in respect of the search query on the first information and the second information; and
a user interface control component that provides the first user with the search results via a user interface of the computer system.

23. The computer system of claim 22, wherein the first social networking service and the second social networking service are operationally unrelated to one another.

24. The computer system of claim 22, wherein at least one of the at least one second user and at least one of the at least one third user is the same user.

25. The computer system of claim 22, wherein the search has also been effected on third information having been received from a second database operationally unrelated to the first social networking service and the second social networking service, the third information being related to at least one of the first information and the second information.

26. The computer system of claim 22, wherein the user interface of the computer system includes a screen, the search results appear on the screen as at least a user-navigable series of stacks, and a visual attribute of each stack provides an indication to the first user of a relative amount of the search results in that stack.

27. The computer system of claim 22, wherein the user interface of the computer system includes a screen and the search appears on the screen as at least user-navigable series of items, and the first user is provided with additional information in respect of an item of the search results upon the first user gesturing on the screen of the client device.

28. The computer system of claim 27, further comprising, an additional information retrieval component for retrieving the additional information other than via the search in respect of the search query.
